(19) United States
(12) Patent Application Publication
(10) Pub. No.: US 2021/0182390 A1
(43) Pub. Date: Jun. 17, 2021

(54) MEMORY MANAGEMENT TO REDUCE RISK OF MALICIOUS THIRD-PARTY ATTACKS

(71) Applicant: Mark Winterrowd, San Francisco, CA (US)

(72) Inventor: Mark Winterrowd, San Francisco, CA (US)

(21) Appl. No.: 17/138,848

(22) Filed: Dec. 30, 2020

Related U.S. Application Data
(63) Continuation-in-part of application No. 16/374,733, filed on Apr. 3, 2019.
(60) Provisional application No. 62/824,987, filed on Mar. 27, 2019.

(51) Int. Cl. G06F 21/56; G06F 3/06

(52) U.S. Cl. CPC G06F 21/56; G06F 3/0604; G06F 3/0673; G06F 3/0653; G06F 3/0622

(57) ABSTRACT

Briefly, embodiments, such as methods and/or systems for techniques for memory management to reduce risk of attacks by malicious third-parties, for example, are described.

### BACKGROUND

### 1. Field

This disclosure relates to memory management of a computing system and, more particularly, to techniques for memory management of such a system to reduce risk of attacks by malicious third-parties, such as via malware.

### 2. Information

It is well-known that for computing systems, such as typically, desktop computers and/or laptop computers, in recent years, a proliferation of malware of various sorts has taken place. In this patent application, the term computer architecture (also referred to simply as “architecture” or the like) refers to the functionality, organization and/or implementation of a computing system, which may, for example, comprise a computer. Thus, the terms “architecture”, “system architecture”, “computer architecture”, “device architecture”, “computing system”, “computing device”, “system”, “device” and/or the like may be used interchangeably without loss of generality or understanding and, in an implementation, typically includes hardware and software, and may also include firmware. Likewise, in this context, the term malware refers to any piece of software that was written with the intent of damaging a computing system, stealing content, and/or generally interfering with the normal operation of a computing system. Examples of malware include so-called “viruses,” “Trojans,” “spyware,” and/or “ransomware.”

A variety of types of commercially available software from companies, such as McAfee or Symantec, exist to provide protection for computing systems from such malware. However, it would be desirable if, instead or perhaps in addition, such computing systems could operate in a manner that made them less susceptible to attacks from malware (e.g., software, written by malicious third parties, intended to damage and/or interfere with normal operation of a computing system).

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description, if read with the accompanying drawings, in which:

FIG. 1 is a schematic diagram of an example embodiment of a tagged memory system;

FIG. 2 is a schematic diagram of an alternative example embodiment of a tagged memory system;

FIG. 3 is a schematic diagram of another alternative example embodiment of a tagged memory system;

FIG. 4 is a schematic diagram of an example embodiment, similar in some respects to the embodiment of FIG. 3, with some additions, such as illustrating a processor;

FIG. 5 is a flowchart of an example embodiment of an in_current_function_operation;

FIG. 6 is a flowchart of an alternative example embodiment of an in_current_function_operation;

FIG. 7 is a schematic diagram of an example embodiment in which a memory location for a return address includes an annotation for a function_operation_start_address;

FIG. 8 is a schematic diagram of an example embodiment employing a virtual page indexing approach for a function operation;

FIG. 9 is a flowchart of an example embodiment of an is_stack_address predicate check;

FIG. 10 is a flowchart of an alternative example embodiment of a is_stack_address predicate check;

FIG. 11 is a schematic diagram of an example embodiment to implement a create_stack_object_pointer operation;

FIG. 12 is a schematic diagram of an example embodiment in which stack_object_pointers are employed;

FIG. 13 is a schematic diagram of an example embodiment in which a stack floor is employed;

FIG. 14 is a schematic diagram of an example embodiment of an implementation of a tracked_reg_state;

FIG. 15 is a schematic diagram of an example embodiment that includes a local computing system network and a computing and communications network between computing systems;

FIG. 16 is a table showing a breakdown of an example embodiment of a return address;

FIG. 17 is a table showing a breakdown of an example embodiment of a stack_object_pointer;

FIG. 18 is a table showing a breakdown of an alternative example embodiment of a stack_object_pointer; and

FIG. 19 is a table showing a breakdown of an example embodiment of a tracked_reg_state.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular described features, structures, characteristics, and/or the like are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the present patent application, particular context of description and/or usage provides helpful guidance regarding reasonable inferences to be drawn; however, likewise, “in this context” in general without further qualification refers to the context of the present patent application.

As mentioned previously, it is well-known that for computing systems, such as typically, desktop computers and/or laptop computers, in recent years, a proliferation of malware of various sorts has taken place. Likewise, a variety of types of commercially available software from companies, such as McAfee or Symantec, exist to provide some measure of protection for such computing systems from such malware. However, it would be desirable if, instead or perhaps in addition, such computing systems could operate in a manner that made them less susceptible to attacks from malware (e.g., software, written by malicious third parties, intended to damage and/or interfere with normal operation of a computing system).

The present patent application, therefore, describes a variety of techniques and/or approaches that may be implemented so that a computing system, such as a computer, for example, may be less susceptible to various types of attacks from malware. In this regard, it is also noted that the following patent application is incorporated by reference in its entirety: U.S. patent application Ser. No. 16/374,733, titled “MEMORY MANAGEMENT TO REDUCE RISK OF THIRD-PARTY ATTACKS,” by Winterrowd, filed on Apr. 3, 2019, and assigned to the assignee of the presently claimed subject matter. As shall be described in more detail below, one manner of attack relates to interfering with and/or affecting proper execution of instructions by a particular computing system (e.g., the computing system being “attacked”). In general, for a computing system, the system executes instructions substantially according to a flow based at least partially on the instructions themselves, including the manner in which the instructions are ordered. In this context, this shall be referred to interchangeably as “flow control”, “flow of control”, “control flow”, “control of the flow” and/or the like without loss of generality and/or without loss of understanding. Thus, one manner of attack for computing systems relates to interfering with and/or otherwise disrupting the integrity of flow control as dictated in large part by the instructions themselves.

One susceptible area for a malware-type attack relates to flow control in connection with execution of separate function operations in which calls between the separate function operations take place, as shall be explained. A function operation, here (e.g., in this context), refers to a block of related executable instructions (e.g., computer instructions) that perform a particular task as a result of execution thereof. A first function operation may be called by a second function operation during execution of the second function operation, as an example. As a result of such a call, typically, during execution of the second function operation, the second function operation had flow control with respect to execution of the particular program that includes these function operations, but as a result of the call to the first function operation, flow control is passed to the first function operation. It is noted that the term “program” and/or the like is defined, infra. Likewise, the call to the first function operation may include (but need not necessarily include) one or more arguments (e.g., one or more values in the form of signals and/or states) that are to be passed to the first function operation as part of passage of flow control to the first function operation.

The first function operation typically will then execute its instructions, using the one or more arguments provided, if any arguments are provided with the call, and after completing execution of the instructions for the first function operation, flow control is then typically returned to the second function operation at the instruction located sequentially in terms of instruction execution immediately after the call to the first function operation. Typically, although not necessarily, a value or values, again, in the form of signals and/or states, may also be returned, the returned value or values being the result of execution of the instructions of the first function operation. It is noted here that the first function operation in the previous example is sometimes referred to as the called function operation (e.g., “callee”) and the second function operation in the previous example is sometimes referred to as the calling function operation (e.g., “caller”). Thus, for one or more embodiments, various techniques and/or approaches are described below to reduce susceptibility of flow control to unintended disruption and/or interference in a situation in which, during program execution, calls take place between two or more separate function operations, such as in the foregoing illustrative example.

For state of the art computing systems, such as computers, a particular region of memory, comprising memory address locations of the computing system, may be referred to as an address space with respect to the memory address locations of the particular region. Likewise, a state of the art computing system (e.g., computer) typically provides a particular region of memory (e.g., an address space) for use by programs, referred to as a stack. One typically use of a stack is to provide relatively fast allocation and/or deallocation of a portion of the memory address locations within the particular region of memory, such that particular portions within the particular region of memory of the stack may be reserved respectively for use with respective particular function operations of one or more particular function operations. A respective reserved portion within the particular region of memory, of multiple reserved portions within the particular region of memory, may be referred to as a frame, in which a respective frame may be separately specified for particular use for a respective particular function operation of the one or more function operations. Thus, a particular function operation has a reserved region of memory associated with it that is referred to as a frame of the particular function operation and the frame of the particular function operation resides within the stack of the computing system.

Along similar lines, another area susceptible to interference from malware relates to memory address locations that are reserved for particular function operations. In an embodiment, for example, memory address locations within the stack reserved for a particular function operation are not to be read from or written to by a different function operation. One exception being if the particular function operation has in some manner permitted the different function operation to access the reserved stack memory locations reserved for the particular function operation. Likewise, after the particular function operation has completed execution, such reserved memory locations are not to be read from or written to any longer as reserved memory locations of the particular function operation. Thus, specifically, for one or more embodiments, approaches and/or techniques for reducing susceptibility of memory address locations reserved within the stack for a particular function operation to unintended disruption and/or unintended interference is described.

It is likewise noted that execution of a call to a function operation is another area potentially susceptible to malicious interference, particularly with respect to registers (e.g., memory address locations) that are used as part of the execution of the particular function operation. Thus, in one or more embodiments, approaches and/or techniques are described so that such registers (memory address locations and associated contents) are safely saved, restored, and/or cleared, substantially as expected in accordance with generally accepted calling conventions, as described later infra., while reducing risks for malicious interference.

Various embodiments of techniques and/or approaches just alluded to are provided below. It is noted that these embodiments, while provided primarily as illustrative examples, appear to have advantages over other approaches that might be employed and/or that have previously been employed. Embodiments described, for example, appear to be simpler to implement, appear to result in less additional memory traffic and/or appear to result in less additional other overhead than prior approaches intended to address the issues described previously. Furthermore, in at least some cases, prior approaches did not reduce susceptibility for all function operations of a computing system and, instead, did so for those function operations considered to be more “highly valued” with respect to completion of tasks by the particular computing system. This may have been at least partly due to issues of overhead and/or cost in terms of reduced overall system performance having been balanced relative to reduce susceptibility to such attacks. However, in an embodiment, as described later, for example, such susceptibility may be reduced for all function operations that may be called and in a manner that is potentially able to achieve a smaller and/or more acceptable amount of degradation, if any, in overall system performance.

A function operation may process an object (e.g., execute a particular task with respect to content for a particular object). An object refers to a set of memory locations that store content in the form of memory states such that the states of those memory locations relate to one another with respect to the object. For example, an object may comprise a table of names and/or a table of memory address locations. An object allocated in the frame of a particular function operation is generally understood to be “private” to that particular frame by default. In general, the notion that the object is “private” to the particular frame means that the particular function operation may access the particular object, but other function operations may not do so, that is, unless those other function operations are provided authorization to do so in some particular manner. In one example, such authorization for access may be provided if a particular function operation were to take the memory address location of a particular object in the frame of that particular function operation and pass it to another function operation, thereby providing authorization to the another function operation. That memory address location of the particular object that is passed, in the example immediately above, may here (e.g., within the context of the present patent application) be referred to as a pointer. One mechanism in which such authorization may be provided is a situation in which a particular function operation (having the object in its particular frame) calls another particular function operation and passes the pointer. Thus, the callee function operation would via such a technique receive authorization to access the object.

It is generally considered a “bug” or an attack if a callee were to access an object in a frame of a caller without appropriate authorization, such as through a pointer not derived from one that the caller function operation passed to the callee function operation. However, despite this general understanding, for a state of the art computing system, there are no well-known or commonly accepted standard methods and/or approaches to address risks associated with an occurrence that might violate the foregoing understanding.

In the present patent application, however, one or more embodiments of a method and/or system in accordance with claimed subject matter is described to at least partially mitigate risk associated with another function operation accessing a particular frame of a particular function operation within the stack without having authorization to do so (e.g., such as in the manner previously described and/or otherwise by malware). Likewise, another embodiment of a method and/or system in accordance with claimed subject matter is described to permit use of pointers for objects to be passed between separate function operations, but in a manner that at least partially mitigates risks associated with malware. Risks, such as, for example, using such pointers to inappropriately access objects stored in a particular frame for a particular function operation within the stack. In an embodiment of a method and/or system in accordance with claimed subject matter, for example, pointers are employed in a manner to make it a challenge to successfully “fake,” so to speak, a genuine pointer and/or to make it a challenge to use a genuinely provided pointer after the called function operation (e.g., “callee”) has finished its execution and flow control has returned to the calling function operation (e.g., “caller”).

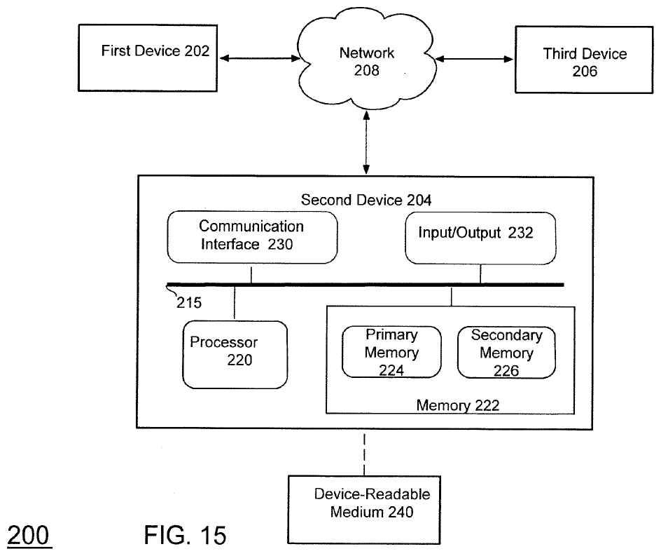

For purposes of illustration and/or convenience of discussion, a high-level description of state-of-the-art memory management technology is provided below. In general, a computing system, such as a computer, comprises a processor coupled via a bus to a memory, such as illustrated, for example, in FIG. 15 by device 204 of embodiment 200. Later in this patent application, a further description of FIG. 15 is provided; however, as shown in FIG. 15, device 204, provided to illustrate a typical computing system, has a processor 220, a memory 222 and a bus 215. Likewise, although not necessarily relevant for the details of this immediate example, memory 222 may, in an embodiment, comprise a primary memory 224 and a secondary memory 226, in which primary memory may perform storage and retrieval faster than secondary memory, for example. Likewise, even longer term storage may comprise device readable medium 240, which may, for example, comprise a hard drive, a compact disk (CD), a digital versatile disk (DVD), etc. Additionally, typically, device 204 may comprise components for communication with other devices, such as communication interface 203, and/or components to permit interactions between the computing system and a human operator of the computing system, shown as 232 in FIG. 15. Again, these features are described in more detail later.

With respect to interactions between a processor, such as 220, and memory, such as 222, it is generally known that memory may store, in a first set of memory locations, instructions capable of being executed by processor 220, termed executable instructions herein, as well as store in another, or second, set of memory locations, physical states that may comprise various values of various types that are to be processed as a result of execution of the stored executable instructions. Typically, values are stored within memory as binary states, referred to here, for convenience, as binary digital signals and/or binary digital states. However, the states stored within memory may be understood, in accordance with instructions to be executed, to represent values of various types such as, to provide illustrative examples, logical or binary values, fixed point decimal values, floating point decimal values, alphanumeric values, hexadecimal values, etc., as is known. It is, of course, noted that claimed subject matter is not intended to necessarily be limited to examples provided largely for purposes of illustration, since such examples may at times be simplified for ease of comprehension. Thus, other types of values may also be represented via storage in a binary digital form, such as a physical state and/or physical signal. Likewise, along similar lines, it is also noted that memory locations may also be employed to store results after having executed instructions in which the results may comprise various values of various types, including those mentioned previously, while physically, again, being stored as a binary digital signal and/or state within memory as contents of a set of memory address locations.

In general, an executable instruction comprises an instruction expressed as some number of bits, where a bit comprises a logical (e.g., binary) one signal and/or state or a logical (e.g., binary) zero signal and/or state and is stored in a memory location. For example, an executable instruction may comprise 16, 32 or 64 contiguous bits, as illustrative examples. Thus, a memory address location for an instruction (and/or for a stored value) may comprise, in effect, a single register, or a portion thereof, having a length (also herein at times called a width) of 16, 32, or 64 (again, as merely illustrative examples) contiguous individual memory “bins,” so to speak, in which a single bit per bin is capable of being stored, for example. Thus, a memory address location, for example, may comprise 64 (for example) physically contiguous memory bins that together store the contents of that particular memory address location. Likewise, one executable instruction may comprise contents of multiple (e.g., more than one) memory address locations. That is, a single executable instruction is not necessarily limited to being stored as contents of a single memory address location, in a particular embodiment; whereas, a single executable instruction, as described in more detail later, may also comprise a portion of the full contents stored within a single memory address location. Likewise, instructions may be, but are not necessarily, all of a particular fixed size, such as a length of eight bits, for example.

An executable instruction may be read from memory to be loaded into a processor (also at times referred to herein as a central processing unit or CPU) of a computing system to direct the processor to perform some action. Executable instructions may all be of some fixed size, as mentioned above. Likewise, in some systems, as also mentioned above, the size of a particular instruction may be specified by bits stored as a subset within a memory address location storing the particular instruction, depending at least in part on the particular architecture and the particular mode in which the processor may be operating, for example.

Generally, a task to be performed in accordance with a particular executable instruction stored at a particular memory address location typically involves: (a) reading stored bits (e.g., in the form of signals and/or states) from a memory location other than the particular memory address location that stores the particular instruction, or from the particular memory address location that includes the instruction itself, (b) performing some mathematical and/or logical operation, (c) writing the results of the operation to a memory address location for storage, and/or (d) specifying another memory address location that stores the next instruction that is to be executed by the processor.

An instruction that, for its execution, specifies, without a condition to be satisfied and/or calculation to be performed, another memory location address storing another instruction to be executed, is referred to here (e.g., in this context) as a jump. An instruction that, for its execution, specifies another memory location address storing another instruction to be executed, but subject to the result of some condition to be satisfied and/or some calculation to be performed, is referred to here (e.g., in this context) as a branch. If the executed instruction, however, does not specify another memory location address storing another instruction to be executed, a processor, such as a central processing unit (CPU), for example, will generally load contents of the memory address location immediately after the memory address location of the current instruction and interpret the loaded contents of that memory address location as the next instruction to be executed; this is referred to as “instruction fall through” and an executed instruction that necessarily undergoes instruction fall through is referred to as a “fall through instruction.”

Operationally, order of execution of instructions is typically implemented using a program counter (PC), also commonly called the instruction pointer (IP) or sometimes called an instruction address register (IAR), called an instruction counter, or called part of an instruction sequencer. In general, these terms refer to a memory address location (e.g., register) with contents that indicate where a CPU or processor is in its program sequence for a particular program being executed. Usually, the PC is incremented by one after fetching from a memory address location an instruction that is be to executed. This, in illustrations provided herein, the PC holds the memory address location whose contents comprise (e.g., “points to”) the next instruction that is be executed. Typically, a CPU or processor usually fetches instructions to be executed sequentially from memory, but, as has been suggested, control transfer instructions may be employed to affect flow control. Operationally, using a PC, for example, the sequence of instructions is changed by placing another value in the PC other than the next sequential value, such as in connection with execution of a jump instruction (or a call instruction, described below), for example.

An instruction that transfers flow control to another function operation is referred to here (e.g., in this context) as a “call” instruction (alternatively, as a “jump and link” instruction). A call instruction specifies some other memory address location storing an instruction to which the program being executed will transfer flow control; a memory address location that a call instruction targets in this manner is referred to as a function operation start address. It is noted here that the term “memory address location” is used interchangeably throughout this patent application with the terms “address”, “memory location”, “memory address” and/or the like without loss of generality and/or without loss of understanding. It is also noted that the terms “program”, “computer program”, “software”, “code”, and/or the like are used interchangeably without loss of generality and/or without loss of understanding throughout this patent application to refer to a set of instructions, such as source code or object code, that a computing system, such as a computer, is able to execute to perform a specific task, although the specific task may be a complex task comprising many sub-tasks, for example. Thus, for example, the set of instructions executed as a result of a call instruction may be thought of as a program; however, likewise, it may be (and typically is) a component of a larger program that includes that set of instructions. Likewise, in a circumstance in which a program (e.g., computer program) performs a call instruction, it is generally expected that the set of instructions executed as a consequence of transferring flow control to the targeted instruction will ultimately transfer control back to the instruction residing in the memory address location that is sequentially directly after the memory address location containing the call instruction (unless an exceptional circumstance occurs, such as a function operation that will eventually be called during execution of the program making a request that the program be terminated entirely for some reason). Although a call instruction may be considered a jump instruction, the fact that it accomplishes some task and, after that task is finished, executes the instruction stored in the memory address location that is sequentially directly after the memory address location containing the call instruction allows us to view a call instruction as providing the illusion of being a type of “composite, custom” fall through instruction. The collection (e.g., set) of instructions arranged to accomplish a particular task in this composite fashion is referred to throughout this patent application as a function operation (to distinguish it from a “function,” such as, for example, a pure mathematical function that may be, but is not necessarily, executable by a computing device).

Likewise, the set of memory address locations that store the instructions of a function operation are referred to as a function operation address set, which comprises the complete set of memory address locations in which the instructions of a particular function operation are stored, including the “function_operation_start_address.” Likewise, it is noted that, for ease of comprehension, name descriptors, in which the name of a signal value and/or a state value may indicate how the value may be used, such as the foregoing example (“function_operation_start_address”), are used through this patent application, but are not intended to be limiting. Rather, name descriptors are provided solely for ease of comprehension. Thus, for example, as just indicated, a “function_operation_start_address” is a name descriptor for the memory location address that stores the first or starting instruction of a particular function operation.

Although not necessarily a requirement with respect to subject matter claimed, in general, it is typical for a compiler of software instructions to tend to associate a given software instruction that is stored in a given memory address location with at most one function operation. Compilers are discussed in additional detail infra. Likewise, it is typical for a compiler of software instructions to group the function operation address set as a contiguous block of memory location addresses, and typical to place the “function_operation_start_address” for a particular function operation as the numerically lowest memory address location in the contiguous block for that particular function operation.

Conventionally, it is expected for a function operation to be provided a memory address location to which flow of control for the overall set of instructions being executed (e.g., a program) is to be transferred after execution of the function operation, called a “return address,” which is a memory address location containing the next instruction to be executed after such execution. Typically, in many situations, this memory address location would be the memory address location sequentially immediately after the memory address location containing the call instruction which initiated execution of that function operation. However, in some, if not many, computer architectures, the return address is provided to a function operation using a specific register, such as a register within memory 222 of FIG. 15 or a register within processor 220, for example. This is referred to as the “return address register” (abbreviated as “RA”). Likewise, for an embodiment, a pre-arranged memory address location in memory, as an example, may be provided into which a function operation may load a memory address location to indicate the memory address location of the next instruction to be executed after completion of the function operation as a result of execution of a call instruction.

Throughout this document, reference is made to RISCV64 solely for purposes of illustration. Claimed subject matter is not intended to be limited to illustrative examples, such as references made to RISCV64. Again, such examples are provided merely as illustrations for ease of comprehension. RISCV (pronounced “risk-five”) refers to an open-source hardware instruction set architecture (ISA) that employs established reduced instruction set computer (RISC) principles. Thus, it is publicly available for use without paying royalties. Likewise, RISCV64 refers to a 64-bit version, meaning that machine words of the hardware instruction set are 64 bits long, rather than, for example, 32 bits, as in other versions. In general, RISCV (also denoted as RISC-V) has a modular design with alternative base parts, that may also include added optional extensions. An ISA base and its extensions for RISCV64 were developed in a collective effort between industry, the research community and educational institutions. The base of RISCV64 specifies instructions, control flow, registers, memory and addressing, logic, etc. The base may be used to implement a basic general-purpose computer (e.g., a computing system), with full software support, including a general-purpose compiler. Thus, referring to RISCV64 as an illustration, the two instructions used to accomplish calls (the jal and jalr instructions) indicate a “link register” that stores a return memory address as part of the instruction execution; by convention, therefore, in this illustrative example, the link register operates as a RA for the RISCV64 architecture.

It is noted here that, in general, it is not proper for a call instruction to execute a call to an instruction that is not deliberately intended to be called, such as an instruction that the particular architecture would not intend to be called or an instruction which the party or entity that wrote the code being executed would not have intended to be called. However, despite this general understanding, there are no standard methods for state of the art computing systems (e.g., state of the art architectures), such as computers, to address a situation in which this general understanding may be violated during code execution. Along similar lines, in general, it is also not proper during execution for a program to jump into a function operation other than to the start address for the function operation or to the return address provided. However, again, despite this general understanding, there are no standard methods for state of the art computing systems (e.g., state of the art architectures), such as computers, to address a situation in which a violation of this general understanding may take place during code execution. Thus, third parties may write code (e.g., malware and/or the like) to interfere and/or otherwise disrupt operation of a legitimately operating program through exploitation of a lack of an existing approach for state of the art computing systems to address potentially improper actions, such as these.

As suggested previously, function operations may also, in some situations, be provided one or more signals and/or states as part of execution of a call instruction, called arguments, which may be used in connection with execution of a function operation, and may also, in some situations, provide some signals and/or states to be “returned,” that is, to be provided after execution of the function operation is complete, referred to previously as return values. Depending at least in part on the particular architecture, arguments and/or return values may be provided via storage within registers (e.g., particular memory address locations) used for this purpose and/or may be placed on the stack of the particular computing system so that the function operation being executed is able to load them and/or has a place to store them, as the case may be.

As is currently understood, code to be executed is written in a particular programming language and such languages have a set of associated rules and/or syntax that is to be followed. Thus, existing programming languages have rules associated with function operations as well. It, therefore, is reasonably typical for a programming language (e.g., via compilation of a program including the function operations) to provide a function operation with a type of temporarily allocated storage for use by the function operation during execution thereof. Typically, storage of this sort is called local (or automatic) storage. As suggested, such local storage is temporarily allocated during execution of a function operation for use by the function operation and, likewise, such local storage, being temporary, is deallocated after execution of the function operation is complete, typically within a region of memory referred to as the stack, discussed previously and in more detail below.

As alluded to, architectures have similar, but sometimes different conventions. For example, local storage for a function operation may sometimes be implemented via processor memory (e.g., memory that is included as part of the processor itself), although processor memory is typically limited and, thus, typically comprises a highly valued resource. Another approach to implement local storage for a function operation involves a pre-established memory structure of a certain size that is able to be quickly reserved for use and then quickly released after use is complete, as suggested above. Thus, this memory portion may be quickly allocated at the initiation of a function operation and may be de-allocated after completion thereof. Typically, stack memory, as previously described, may be used in such a manner.

It is also noted, however, that a processor may also include an ability to execute multiple threads of flow control concurrently, described in more detail infra. However, even for a processor capable of executing multiple threads, separate portions of memory may be reserved as separate stacks associated with separate threads of flow control. For a particular stack (e.g., such as for a particular thread of flow control), usually a contiguous range of memory address locations are reserved. Such a group of memory address locations is referred to as a stack range, in this example, for the particular thread of flow control. Memory address locations for use as a stack are typically reserved in a dense fashion, starting from one end of a stack range with a memory address and increasing or decreasing the range of reserved stack space by using a memory address to delimit the other end.

For clarity of explanation, illustrative embodiments described herein shall assume a stack that starts at a numerically higher memory address for one end of a stack range and proceeds down towards a numerically lower memory address for the other end of a stack range as stack memory address locations are reserved. This is the more typical approach employed; however, likewise, claimed subject matter is intended to not be limited in scope in this respect. Thus, claimed subject matter is also intended to include a stack that begins at a numerically lower memory address for one end of a stack range and proceeds to a numerically higher memory address for the other end of a stack range as memory address locations are reserved.

Given the above assumptions, if a memory address location x on the stack is reserved for a function operation, this implies that memory address location (x+1) is within the stack range and is also reserved, unless x is the last address mapped to be used by the stack (the numerically largest stack address); in this case x+1 can be some other form of memory. The boundary between reserved memory and unreserved memory is tracked with a register storing a memory address, referred to as a “stack pointer.” A stack pointer is usually not tracked in a memory address location. Most computing architectures reserve a special on-CPU register for describing the stack pointer. This is typically because this value is desired quickly and often; as such, accessing a memory location may be too slow. However, a stack pointer may be stored at a memory location at times in which it is not actively in use, such as in connection with “context switches” (described in more detail infra.). A stack pointer for a given stack range “points to” the memory address one greater than the numerically highest memory address location of the stack that is not yet reserved, or equal to the numerically lowest possible memory address in the stack range if all memory address locations available for the stack are reserved.

There exist circumstances in which, through large amounts of effort, some compilers allow for a stack to be discontiguous, with different contiguous stack ranges scattered throughout memory. This is done to preserve the illusion of a contiguous stack while gracefully handling the case where the stack grows so large that it threatens to expand into a page reserved for non-stack use. The mechanism described here, in which a different addressing mode is used to access the stack, addresses the concern of the stack running into non-stack memory; thus, stack and non-stack memory would not “collide.” The mechanism described here, for an embodiment, makes a discontiguous stack less desirable. Given the complexity that such a stack might otherwise add, an embodiment may not necessarily handle it.

Of course, the stack pointer may be tracked using a variety of approaches, such as a special purpose register or a pre-reserved memory address location, and claimed subject matter is intended to include all such variations. In a typical approach, a stack pointer comprises a general-purpose register (referred to here as “SP”), rather than a memory address location, that includes as its content a memory address. Thus, for example, a function operation is able to quickly reserve space for itself by decrementing a number of bytes from the memory address stored by the stack pointer register (SP) and is able to quickly release this space to be available for use by another function operation at a later time by adding this number of bytes back to the memory address stored by the SP. For clarity and for ease of discussion, this convention shall be assumed for the embodiments described herein, although, again, claimed subject matter is not intended to be limited to embodiments provided primarily for purposes of illustration, which includes conventions for such embodiments, of course.

In many calling conventions, memory addresses “comparing” greater than or equal to the stack pointer (e.g., using a comparison-type instruction) are reserved for use by the current function operation being executed (or by a function operation that called the current function operation being executed, as shall become clear). For clarity, the term current function operation refers to the function operation with flow control of the instructions being executed by the processor. Those memory address locations “comparing” less than the stack pointer are generally considered not yet reserved. Furthermore, after control flow is transferred to a “callee” function operation, by convention, the stack pointer points to the last memory address location on the stack that was reserved by the “caller” of the “callee” function operation (likewise, for the initial function operation to be called, the last memory address location reserved for that function operation, after it calls a function operation, or the memory address location just off the high end of the stack range). The value of this memory address location is referred to as the frame pointer. If the “callee” function operation desires additional stack space, such as for interim storage with respect to its own local computations, it may decrement the stack pointer to reserve additional space (e.g., to reserve space within the stack range) Memory address locations that are greater than or equal to the stack pointer and less than the frame pointer are considered to be reserved by the “callee” function operation, in this example; this range is called the stack frame for that function operation.

If the stack pointer is greater than the frame pointer, this implies that the current function operation had or has access to a portion of reserved memory that does not “belong” to it. The frame pointer is the lowest address of the caller's frame, and the address just after the callee's reserved range. If the stack pointer (the lower bound of the current function operation, the “callee” function operation) is greater than the frame pointer, this means that the current function operation, the “callee” function operation, has moved the stack pointer into its caller's range, and treating some portion of the caller's memory as if it belonged to it. This is generally considered to be outside expected operation or a programming dysfunction, especially if this is the case at the time of a call or return; however, state of the art computing systems, such as computers, do not have a mechanism to address such a potentially improper operation or dysfunction such as this. It is also expected, by convention, that a “callee” function operation resets the stack pointer to be equal to its frame pointer (e.g., to release the memory address locations for other use) before it returns, but modern state of the art computing systems, again, have no standard method for addressing a potential violation of such an expectation.

Although it is generally considered improper for a function operation to read from or write to a stack above its frame pointer (e.g., a stack for a frame of another function operation allocated before allocation of the current function operation) there are a few known exceptions. For instance, the C programming language allows function operations to take the memory address location of a local variable and pass it as an argument to a callee function operation. C compilers generally implement this aspect of the C programming language by passing to the callee function operation a memory address location having contents that point to storage reserved for the local variable in the stack frame of the caller function operation. If the callee function operation uses this pointer to write to the memory address location used to reserve storage for the local variable that had its memory address location passed, this is not considered improper (e.g., outside expected operation).

In addition, it is standard practice in many architectures to pass arguments to function operations by placing them on the stack (referred to here, in this context, as “stack arguments”). While some architectures place stack arguments below the stack pointer before a call (thus placing them below what will become the frame pointer of the callee function operation) others place stack arguments directly above the frame pointer. RISCV, for instance, does this in situations in which there are too many arguments to a function operation call to fit into allocated argument registers. Thus, with stack arguments placed above the frame pointer, it is not considered improper for a function operation to access the memory address location above the frame pointer dedicated to those arguments, but it is considered improper for a memory address location past those arguments to be accessed. To simplify operation in conjunction with stack arguments, in a situation in which a caller function operation has more arguments to pass than are able to fit into allocated argument registers, an embodiment in accordance with claim subject matter, for example, may, instead, implement a procedure in which an array of additional arguments is generated within the frame of the caller function operation so that it is able to be passed to the callee function operation in conjunction with execution of the call instruction. This effectively simplifies operation and allows any memory address location of a stack to be clearly in exactly one stack frame, a generally desirable property.

With the foregoing in mind and understanding that malware may attempt to exploit weaknesses in existing memory management for a computing system exposed to such malware, various embodiments of systems and/or methods of memory management in accordance with claimed subject matter are described below.

For example, in an embodiment, it may be desirable to manage memory to make it more difficult for malware, for example, to disrupt and/or otherwise interfere with program flow as a program is executed, referred to as flow control, and/or for malware, for example, to disrupt and/or otherwise interfere with operation of a memory stack, referred to simply as a stack, as previously described. Claimed subject matter includes methods and/or systems to address potential abuses of commonly expected software conventions related to, for example, function operations, including associated frames and/or stacks, as previously illustrated, but while also permitting functionality associated with various commonly-expected software conventions to not be significantly affected, so that, for example, programmers do not need to update their source code for systems and/or methods that may employ an embodiment in accordance with claimed subject matter. To concretely provide a non-limiting embodiment that is illustrative with respect to memory management, an example using a RISCV64 architecture is discussed in various places throughout this document. Thus, again, for purposes of providing an illustrative embodiment, consider a computing system, including related code, such as described and illustrated later with respect to FIG. 15, such as system 200 comprising, for example, computing device 204 or a reasonably similar computing device.

It is noted that previously values (e.g., physical signals and/or physical states) comprising a binary digital form, referred to as bits have been discussed. In general, it is understood in the context of a computing system, for example, that a group of bits comprises physical binary digital signals and/or physical binary digital states expressed in a base 2 form that are convertible to an integer value in base 10, for example. Thus, a signal and/or state may comprise a physical representation of a positive integer value. Likewise, this interpretation of a group of bits is typically referred to as an unsigned integer value or unsigned fixed point value. The fixed point or integer values capable of representation for a particular group of bits is constrained by the number of bits. For a group of x bits, for example, 2\hat{ }x different fixed point values are capable of being expressed or represented with those x bits. To make the possible expressible range of numbers clear, in conjunction with a discussion of a fixed point or integer value, typically the number of bits shall also be mentioned, such as “an 64-bit unsigned integer value,” to provide an illustration. Typically, fixed point or integer values are employed to express positive values. However, in many situations it may be desirable to express negative values (e.g., using physical signals and/or physical states) as well as positive values. Such an interpretation of x bits is referred to as an x-bit signed integer value or fixed point value. While there are numerous ways to represent a signed integer or fixed point value, a common one used today in modern computing systems is referred to as 2's complement, in which, for a signed integer or fixed point value represented in x bits, bit patterns that would be considered to be between 0 and (2\hat{ }(x−1)−1) in an unsigned interpretation are considered to have the same value in the signed representation, while those between 2\hat{ }(x−1) and ((2\hat{ }x)−1) are considered to be negative, mapped from their unsigned fixed point value to their negative signed fixed point value by subtracting the fixed point value 2\hat{ }x from the unsigned fixed point value. Unless stated otherwise, within the present document, a reference to a signed integer value is understood to refer to 2's complement.

Likewise, the RISCV architecture was discussed previously as an illustrative example of a computing system, constructed, so to speak, around a particular CPU (e.g., microprocessor) design. Many computing system architectures, such as the RISCV architecture, provide relative small units of storage that are capable of relatively quick access, called registers. Registers also may be dedicated to some special purpose and may not be directly accessible to a user program, or may be intended to be accessed by the instructions of a program and may, therefore, be associated with some name that may be specified in an instruction. While different computing systems may provide registers to instructions in a variety of sizes and for a variety of purposes, a RISCV64 architecture generally provides two varieties of registers for most instructions: general purpose registers (GPRs), which are intended to store fixed point, bitfield, or pointer values, and (optionally) floating point registers (FPRs), which are intended to store floating point values. The size in bits of the widest general-purpose register usable by a normal ISA instruction is referred to here as a register width. General purpose registers are 64 bits wide for a RISCV64 type architecture. Likewise, the term machine word is a synonym for register width in this context. RISCV64 type architectures also provide another form of register described as a Control Status Registers (or CSRs); these registers generally store signals and/or states to describe aspects related to program execution (such as “time CSR” which provides the current CPU time) or may be set to alter program execution in some way (such as “frm CSR” which alters the floating point rounding mode) although such registers may also be used to provide storage like a general purpose register (such as “uscratch CSR,” storage reserved for supporting trap handlers). CSRs typically are not accessible directly by most RISCV64 instructions. Rather, stored values are typically to be moved into or out of such registers via a small group of special instructions that provides the value to or receives the value from the CSR via a GPR used as an intermediate register. While registers may provide relatively quick access, the amount of storage space provided by registers is limited. Typically, registers are not sufficient to adequately support execution of most programs. CPUs are generally connected to a larger, generally slower, storage medium for use with program execution, commonly referred to as memory, such as we have previously been discussed. However, it is also noted that in some embodiments, although perhaps not typically, registers might be an isolated block of memory designated for a special purpose with appropriate modifications so that the memory locations of the block operate similar to a register.

While some special registers have special policies, two general policies that are commonly described for the management of registers are referred to respectively as: caller-save policy and the callee-save policy. For example, consider a function operation that operates in accordance with a caller-save policy. In this case, for example, the function operation is not expected to preserve the original contents of a register before using it in connection with executing instructions; thus, to continue using the contents of a register both before and after a operation function call, the function operation may include additional instructions to be executed to save the contents of the register before the function operation call (usually to a location in the stack frame of the particular function operation) and, after the function operation call, to restore the contents.

In contrast, consider a function operation that operates in accordance with a callee-save policy. In this case, it is expected that the function operation includes operations specifically to save the prior contents of the callee-save register before the function operation uses the register in connection with execution of instructions for the function operation (again, usually to the stack frame of the particular function operation) and, before the function operation returns, it is expected that the function operation includes operations specifically to restore the contents of that register to its original value. Thus, since the function operation expects the contents of the callee-save register to remain the same both before and after a call, the function operation should not include additional instructions to be executed save and restore the contents of the register before and after a call.

It is noted that although programs may be designed with a particular calling convention in mind, there are no standard methods in state of the art computing systems to address a failure to comply with expectations associated with such calling conventions. This has the potential to be damaging, particularly in the case of callee-save registers. To be specific, a function operation may expose internally generated values or content to its callees and, likewise, the function operation may be designed in a manner that, for proper operation, expects those callees to properly restore such generated values or content. This expectation shall be addressed with an illustrative embodiment in more detail later in this document.

A broad overview of typical memory architecture may be helpful before proceeding with an in-depth discussion of illustrative embodiments of claimed subject matter. A function operation may solely employ its stack frame for storage in connection with execution of the function operation; however, likewise, a program may reserve space in memory that is able to have the program-related content preserved independently of whether or not a function operation has completed its execution. In this case, for example, a function operation may request from the computing system reservation of some additional amount of memory. Reservation of memory for a program based at least in part on a program request at runtime is referred to here as dynamic allocation, and the memory reserved is referred to as dynamically allocated memory. Dynamically allocated memory that has its contents preserved independently of whether or not a particular function operation has completed execution typically comes from a region or group of regions of memory commonly referred to as the heap. Likewise, it is common to describe dynamically allocated memory as heap memory, and to describe content stored in dynamically allocated memory as heap-allocated content, or content stored in or on the heap. A request for dynamically allocated memory usually returns a pointer to the program making the request, in which the pointer points to the newly-reserved memory. Dynamically allocated memory generally persists until a program indicates that it is done with that memory, a process called freeing or deleting memory. If a program frees memory and then attempts to use it for that same purpose after it is freed, this is considered a bug (commonly called “use after free”), as it is quite possible that this memory has been dynamically allocated for a separate purpose since being freed. It is similarly misbehavior for a program to free memory that it has reserved twice; this also may result in memory reserved for a separate dynamic allocation request being unreserved, resulting in a “use after free” later.

Some computing systems, therefore, alternatively may employ a process called garbage collection; in a computing system using garbage collection, the computing system may occasionally inspect memory in an attempt to identify reserved portions of memory no longer of use to a currently executing program. Garbage collection, however, may be imprecise, in which a garbage collector does not assume it is able to differentiate between a pointer and a fixed point value. It may, for example, assume that all fixed point values are potential pointers and, thus, may not free much memory that may actually no longer be usable by a currently executing program. In computing systems where there is a reliable differentiation between a pointer and a fixed point value; however, a garbage collector may be made precise. That is, dynamically allocated memory should typically be freed after it becomes inaccessible by a currently executing program, for example. In this context, for a computing system that is able to provide an indication that a stored value comprises a pointer, that pointer is referred to as a formal pointer or as a reference. While it may be a bug for a program executing in a computing system not using garbage collection to dynamically allocate memory and then never free it (sometimes referred to as a memory leak), this is sometimes intended behavior: for instance, a program may be created with an expectation that some of the memory that has been dynamically allocated will continue to be used until the program finishes. Thus, it may be intentional for the program to finish without freeing dynamically allocated memory and, instead, expect the operating system to handle memory that has previously been reserved via dynamic allocation. This pattern is sometimes referred to as exit-is-my-garbage-collector.

In addition to stack memory and dynamically-allocated memory, programs commonly expect regions of memory to be reserved (and possibly to be pre-filled) before or at the start of a program and for pointers to that memory to be made available to the program before the portion of the program that refers to that memory is executed. Typically, such memory is referred to as global memory, and content represented therein may be referred to as global content or, more simply, as a global. Global memory may often be used to store instructions that a program expects to execute (also perhaps segregated into a subregion of global memory referred to as text memory), constants that a program expects to use (such as messages the program may display to a user), and content that is expected to be accessed in many different places in the program.

Global content typically is set up before a program (or a subportion of a program) is run via execution of another program called the loader. The loader reads a file, called an executable file, that describes the global content of a program (usually including its instructions) and how the program expects that content to be laid out in memory. The loader then follows those instructions to reserve and fill global memory. Often, an executable file will specify within it an entry point, to which the loader will then transfer control, starting the program. There are many formats in which an executable file may be provided; in this document, merely for purposes of illustration, executable files are understood as using the format referred to as the Executable and Linkable Format (ELF), which is commonly used on Unix and Linux-type operating systems.

Some computing systems may run one program on one CPU at at time; however, it is more often the case that a computing system may, in a particular span of time, attempt to make progress on multiple programs. This may be accomplished by having a computing system that may include multiple CPUs operating in a concurrent fashion. However, instead of or in addition to this, a computing system may likewise occasionally pause one program that a CPU is working on, in order to work on a different program for a while. This process may be initiated by the computing system via instigating an interruption of the control flow of the program currently executing on the CPU in order to execute code permitting the CPU to switch the program it is executing. Interruptions in the execution of a CPU like this are referred to as traps, and the code that a trap executes is usually referred to as a handler. The handler for switching programs typically saves the contents of the registers of the first program (and other state values relevant to execution of the first program) into a special region of memory called a trap frame. The handler typically may then find the trap frame of the program it is switching to (e.g., a second program), load the contents of the trap frame for that program into the registers, and start executing the second program. Execution of the first program may now be paused for an arbitrary period of time; at a later point, the CPU may again begin executing that first program after restoring its trap frame into registers, thus, allowing the first program to continue executing as if it had not been paused. This process of switching between states of programs executing on a CPU is referred to as a “context switch.”

For situations in which a computing system includes multiple CPUs or contains a single CPU that is able to context switch between multiple programs, memory becomes a shared resource between those programs. This may create various technical issues. For instance, in a situation in which a computing system is executing two programs, one of those programs may reserve a large amount of memory for its own use, and it may, thereby, effectively preclude the other program from being able to reserve sufficient memory space for satisfactory program execution. In addition, if one program is poorly-written or malicious, it may accidentally or intentionally write to memory that was reserved for use by another program, with a potential that the other program may load contents from memory not intended to be stored in that location. Various computing systems may attempt to address such risks, for example, by not providing programs with direct access to the address space of a memory device, instead, creating additional layers for an address space referred to as virtual memory. In a common configuration of a virtual memory system, a program may be executed in a manner in which it may appear as if the program is the only program accessing locations from a vast memory device that is illusory. Thus, a program may make requests to load from and store to memory using addresses enumerating the memory locations in this illusory address space called virtual addresses. Thus, a program may be provided its own virtual address space. For a load or a store performed via a virtual address, the computing system translates virtual addresses to physical memory address locations within a physical memory device. Thus, the address space physically used on the memory device is referred to as a physical address space to differentiate it from the virtual address space.

Thus far, the discussion of computing systems at a high level may imply that CPUs load and store directly from memory, although possibly through a virtual address space involving virtual address translation. While this may sometimes be the case, main memory may be relatively slow to access in comparison with the speed at which a microprocessor or CPU is able to execute a program instruction. For this reason, more modern architectures for a computing system may provide storage devices able to implement quick access to a smaller amount of memory; these devices are called memory caches. In general, caches act like a memory device, taking a numerical value, much like a pointer, called a key, and providing the ability to load and store cache memory contents that is associated with that key. The association a cache provides between its key and its cache memory contents associated is commonly referred to as a mapping. Memory caches store within them copies of subregions of main memory associated with a memory address location at which that particular subregion of main memory starts; these subregions are called cache lines. In a computing system in which caches are used, the computing system performing a load or a store with respect to a memory address location of main memory will initially direct the request to a cache rather than to main memory. If a cache line stores the contents associated with the memory location indicated by that address, the cache will service the request; such an immediate servicing is called a cache hit. Otherwise, the computing system may seek to service the request from some larger backing memory storage, which may be main memory itself or which may be another larger, slower layer of cache; this falling back to another layer of storage is called a cache miss. Generally, these layers of caches are named or numbered in a manner to reflect the layers of cache misses that lie between the particular cache and a memory access. Thus, in this illustration, the cache that the computing system hits directly is referred to as the L1 cache, the cache that the L1 cache falls back to on a cache miss is called the L2 cache, etc. Likewise, depending at least in part on the computing system, caches may also be separated based at least in part on whether they are being accessed to load instructions or non-instruction content (e.g., values); these are called instruction caches and data caches respectively, or sometimes I-caches and D-caches. Some computing systems do not permit a region of memory to be used both to execute instructions and to be capable of being modified. Thus, I-caches often do not provide a store operation, while D-caches usually provide a load and a store operation.

In addition to the above caches, it is common in a computing system expecting to use page-type virtual memory to provide a cache that provides a mapping to speed up the process of translating from a virtual page-type address to a physical address. This cache is commonly called a Translation Lookaside Buffer, or a TLB. The TLB is often located in a grouping of hardware dedicated to address translation, commonly referred to as the Memory Management Unit, or MMU.

Although the previous discussion treated a computing system performing context switches and a computing system switching between programs similarly, for a computing system with multiple CPUs, in fact, a program may be break up into tasks that may run nearly or fully independently; often this is done so that a program may run faster in a computing system with multiple CPUs. These independently running subprograms are commonly referred to as threads of control, or simply threads. Threads have their own set of register values that belong to them to be saved and restored via context switches. In addition, a thread commonly has its own region of stack space reserved for its operation. Threads working in the service of the same program often run in the same address space and, thus, typically do not have process isolation between them. The combination of a group of threads that run in an address space and the address space that they run in is commonly referred to as a “process”; a program may create multiple processes to perform separate tasks while also providing process isolation between the threads accomplishing those tasks.

It is noted that programs are written in a high-level language comprehended relatively easily by humans; whereas a CPU executes instructions from its ISA. Thus, a conversion from the program in the high-level language form to ISA instructions is to be employed. One approach is to run the high-level language using a software-type interpreter, which would read portions of the high level language and provide a corresponding set of ISA instructions to the CPU to accomplish the task described by the high-level language portion read. This, however, has the potential to be quite slow. Instead, modern computing systems using high-level languages more typically employ a process called abstract interpretation, and a particular form of abstract interpretation called compilation, which is accomplished by a compiler.

A compiler is a specific form of abstract interpreter that takes as input content a program and also takes as input content (or contains within its own code and its configuration files) a model of one or more CPUs and a description of the associated ISA. Given a program in a high level language, a description or indication of a CPU and ISA, and little, if no, specification about values to be eventually provided to that program as input values, a compiler is able to produce a program largely equivalent to the high level language translated to the ISA of the CPU (or an error if it cannot produce such a program). This translated program may now be executed via the targeted CPU with arbitrary input values for the translated program and should execute in a way that is largely equivalent to the behavior expected for the high level language program.

Within the scope of this document, one high-level language in particular shall be mentioned as an example: the C programming language. The C programming language is selected because it is widely used and supported. Furthermore, it provides relatively few specifications to the programmer about how the C program will be implemented by a compiler and CPU. Such loose mandates provided by the C language allow C compilers to make often useful and subtle ISA-specific implementations of the original C program that result in a faster largely-equivalent form for eventual execution by the target CPU. Likewise, therefore, patterns of assembly code that emerge from C compilers tend to be stable with a reliable pattern, as is desirable. References may also be made to C++, a more-complex language derived from the C language for which C is nearly a C++-compatible language subset.

While discussing the C programming language, GCC (the “GNU compiler collection”) may be mentioned as an example compiler. GCC is one of the most commonly used C compilers. Furthermore, GCC has had a singular influence on the C programming language itself so that GCC provided compiler functionality or GCC provided extensions to the language may result in an equivalent feature in another C compiler or other C compilers may support that language extension. Thus, describing functionality that exists in GCC, often amounts to a description of an additional layer of functionality that is almost standard.

Another form of abstract interpreter often seen in a computing system is a static analyzer, which receives a program (or part thereof) written in some language for processing by a static analyzer to perform some abstract execution with respect to the program. The abstract execution performed by a static analyzer is commonly referred to as a static analysis. Static analyses may be performed during execution of a compiler (static analyses are often used, for instance, for a compiler to produce warnings of misbehavior that may occur within a program) or as a separate program written for that purpose.

An embodiment in accordance with claimed subject matter, as an illustration, is described in a few stages. First, because space allocated on the stack is provided for use by a particular function operation, an embodiment illustrates an implementation in which control flow integrity for function operations is maintained. Then, an embodiment illustrates an implementation in which function operations are able to read from and/or write to the stack below the frame pointer, but not otherwise. Later, an embodiment illustrates an implementation in which any particular function operation is able to provide access to stack locals for the particular function operation in a fashion so that such access may not be used as a vehicle, such as by malware, for example, to interfere with and/or disrupt the operation of another function operation that may later use the same region of stack memory address locations.

Below, example embodiments of maintaining flow control integrity or function operations are described. For example, in an embodiment, the following are examples of desirable aspects for an implementation:
1. valid_jump_property: Any jump or branch instruction, which targets a memory address location outside of the particular function operation in which the instruction is located, to be treated as valid shall target a function_operation_start_address for a caller of the particular function operation or a memory address location intended to store a return address for a caller of the particular function operation and no other memory address location. Likewise any target location within the current function operation should be considered a valid jump target.
2. valid_call_property: Any call instruction, to be treated as valid, shall target a function_operation_start_address and no other memory address location.
3. valid_fallthrough_property: Any fall through from an instruction associated with a particular function operation, to be treated as valid, shall fall through to another instruction associated with that particular function operation and no other instruction.

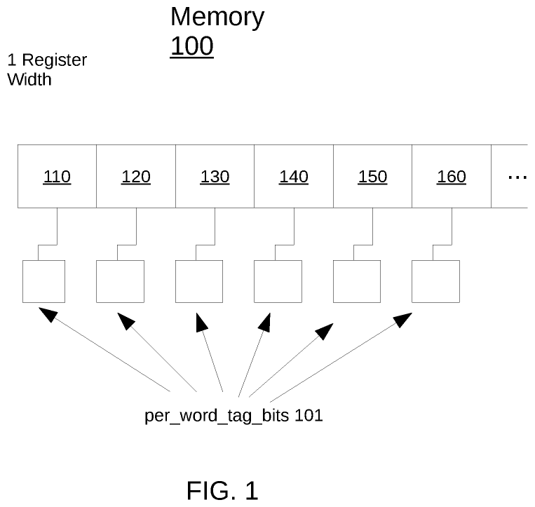

Addressable user memory may be viewed as partitioned into machine-word-sized segments in which a respective segment starts at a word-aligned memory address location, such as illustrated in FIG. 1 by embodiment 100 of memory comprising memory words 110, 120, 130, 140, 150, 160, etc. An embodiment may, for example, via hardware, firmware and/or software associate with a respective memory word some number of bits of storage, referred to in FIG. 1 as per_word_tag_bits, such as 101.

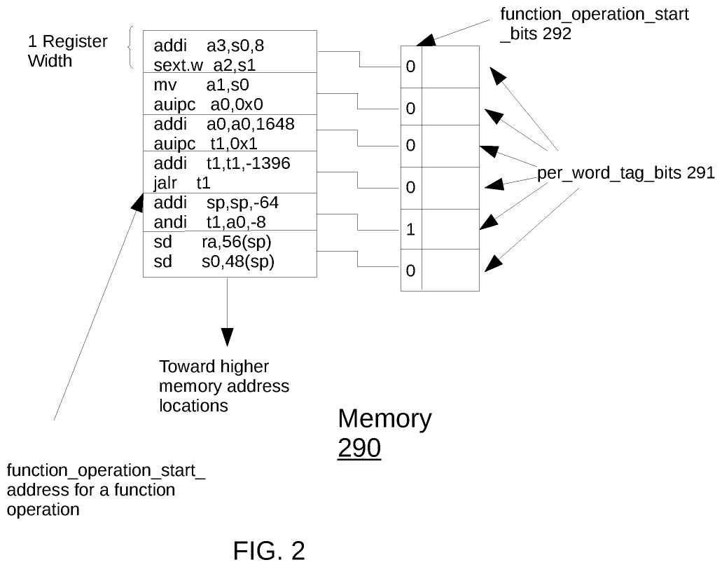

A variety of implementations are possible and are intended to be included within claimed subject matter; in the present embodiment 100, a tagged memory system is illustrated in FIG. 1 to associate bits with machine words in memory. However, FIG. 2 provides an alternative embodiment 290 of memory. For example, for an implementation, at least one bit of per_word_tag_bits 291 may be reserved to indicate whether a machine word contains the start instruction of a function operation; referred to here as function_operation_start_bit (or function_operation_start_bits, as shown in FIG. 2 by 292) In an embodiment, for example, a function_operation_start_bit that contains one bit is sufficient to indicate a machine word as the start instruction for a function operation for an architecture in which one function operation starts at one position within a machine word. Thus, for an embodiment, FIG. 2, illustrates associating respective function_operation_start_bits, such as 292 shown in FIG. 2, with respective memory words, such as those illustrated as part of embodiment 290.

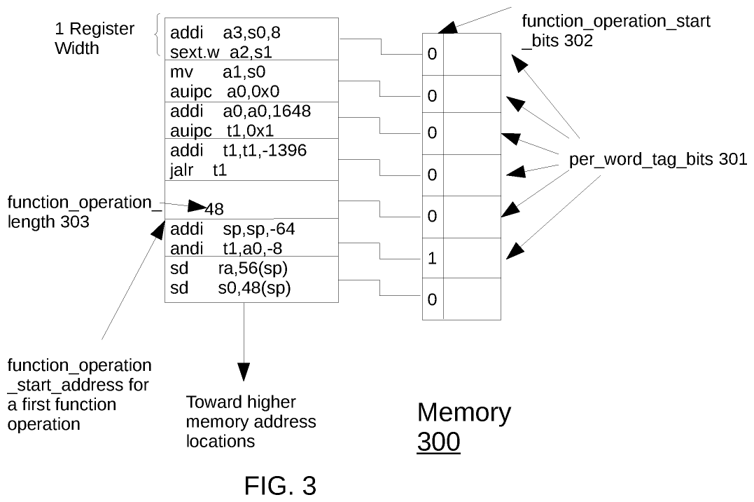

FIG. 3 illustrates yet another embodiment 300 of memory. Embodiment 300 is similar to embodiment 290 shown in FIG. 2. For example, embodiment 300 includes per_word_tag_bits 301 and function_operation_start bits 302. Likewise, embodiment 300 illustrates a function_operaton_start_address, such as for a first function operation. Embodiment 300 also includes a function_operation_length 303 of a first function operation, shown at a memory address location immediately preceding the memory address location for the function_operaton_start_address of the first function operation.

FIGS. 1, 2, and 3 illustrate embodiments for architectures in which function operations comprise aligned machine word boundaries. However, again, additional embodiments are possible and are intended to be covered by claimed subject matter. Thus, this, or other architectures, this may be implemented in connection with code compilation, for example, in an embodiment. Thus, in an embodiment, a compiler may compile code in a manner so that a start of a function operation occurs at word boundaries, as suggested. However, in situations where this may be undesirable for some reason, for example, in still another alternate embodiment, more bits than one bit may be allocated; for instance, in one variant of RISCV64, instructions may be as small as 2 bytes with a machine word being 8 bytes long. Thus, again, as an illustration, in an embodiment that involves such a variant of RISCV64 and in which function operations are not necessarily aligned to start at word boundaries, 4 bits per machine word may be employed to indicate which 2 byte instruction within a particular memory location contains a start of a function operation.

While, in an embodiment, it is possible to annotate every machine word with function_operation_start_bits, the function_operation_start_bits are expected to have non-zero values for machine words containing instructions and otherwise are expected to be zero. Thus, another example embodiment may comprise a computing system (e.g., hardware, software and perhaps firmware, as previously described) able to determine whether a given memory address points to a memory address location in which the contents of the memory address location stores text or stores non-text, e.g., numerical signal values as memory states in a binary digital form. For example, in an embodiment, a system may employ an operation, which may be implemented as hardware, firmware and/or software, able to perform a predicate “check,” so to speak, that is referred to here as an “is_text_address predicate” check. Thus, such an embodiment, for example, may treat some number of per_word_tag_bits as function_operation_start_bits for text content of a memory address location while treating the bits in another manner for content of a memory address location that is non-text. It is noted here that, in general, a memory address location storing text represents an executable instruction.

An is_text_address predicate check may be implemented any one of a number of ways and it is noted that claimed subject matter is intended to cover the myriad of possible implementations. Here, two embodiments are described as sample illustrations. In many virtual memory systems, for instance, virtual page table entries contain a bit indicating whether a virtual page corresponding to a table entry contains executable text, using an “is_text” bit or a “may_execute” permission flag. Thus, in an embodiment employing a virtual memory system including this feature, reading this flag may be used to implement the is_text_address predicate check. As an alternative, in another embodiment, if all text for a particular thread were co-located within a contiguous region in memory, the bounds of this text_region could be marked with text_start and text_end registers, and implementation of the is_text predicate check would amount to implementation of a comparison instruction operation to see whether a given memory address location falls within the bounds stored in these registers.

In an embodiment, in connection with loading instructions for some number of function operations into memory, a system may annotate a memory address location intended to be a function_operation_start_address with a set function_operation_start_bit. Thus, such an embodiment, for example, is able to implement a valid_call_property, as previously described, by verifying, before making a call, that the target memory address location of the call is associated with a set function_operation_start_bit, or verifying, after a call, that the current instruction is associated with a set function_operation_start bit, indicating that it is a so-called “formal” function_operation_start_address. To implement a verification after a call operation, it may be desirable to employ a just_called_bit. Thus, execution of call instructions may set this bit, whereas execution of other instructions may clear this bit. In this manner, in an embodiment, a system may consult whether the state of the just_called_bit is a 1 or a 0 and make a determination as to whether to perform verification that the current instruction is associated with a set function_operation_start_bit, as described.

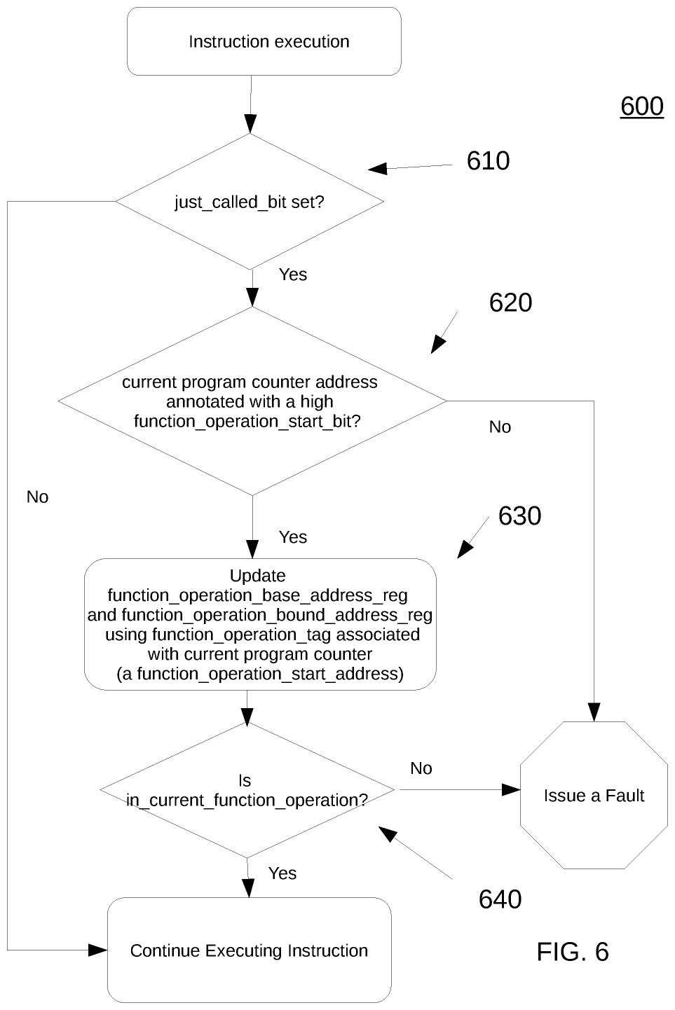

FIG. 6 is a flow chart illustrating an embodiment 600, for example, in which a system (e.g., hardware, software and perhaps firmware, as previously described) checks a function_operation_start_bit, such as, for example, during execution of processor instructions following execution of a call instruction. As was described and as illustrated in FIG. 6, at block 610, just_called_bit is checked. If it is set, then a call instruction was just executed. Thus, at block 620, using the current value of a program counter (PC), a determination is made as to whether the indicated memory address location has a function_operation_start_bit, indicating that the memory address location is a function_operation_start_address. If not, a system fault is issued. If so, various registers are updated at block 630. Likewise, block 640 verifies that the current function operation is the correct function operation using a check, described in more detail below. Again, if not, a system fault is issued.

In addition, in an embodiment, it may be desirable to annotate a function_operation_start_address with some number of bits comprising a function_operation_tag, as has been previously suggested. For example, FIG. 3 illustrates an embodiment in which a function_operation_length may be stored for convenient use in an embodiment. Again, an association may be accomplished in a number of ways and claimed subject matter is intended to cover such alternative implementations.

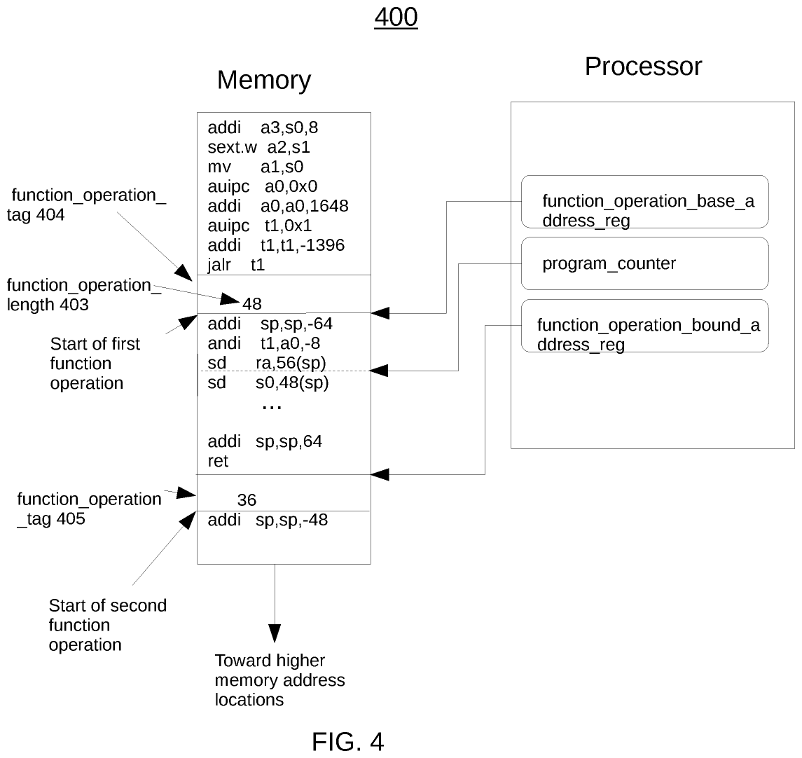

For example, one embodiment may employ a loader to reserve a machine word of memory before a function_operation_start address and the memory address location contents may comprise an associated function_operation_tag. FIG. 4 provides a non-limiting illustrative example embodiment 400, similar in some respects to the embodiment of FIG. 3 with some additions. For example, the embodiment of FIG. 4 includes a processor with registers for a function operation base address, a function operation bound address and a program counter (PC). Likewise, these registers are also illustrated in conjunction with the embodiment illustrated in FIG. 6, previously described.

Another embodiment may use a hash table to convert a function operation start address to function operation tags. For example, a hash table may be stored in a portion of memory accessible by system code that otherwise limits access. Function operations are usually written to memory in connection with loading of a program and/or dynamic loading of a dynamic library. As a result, a relationship using a hash function may be constructed that is customized, so to speak, to the program or library to be loaded. Likewise, other techniques and/or approaches for associating a function operation with various tags are possible to implement, especially for alternative architectures. Such other techniques and/or approaches are intended to be included within claimed subject matter.

As noted, it may be desirable for a computing system to be implemented in a manner so that conventional expectations regarding software being executed by such a computing system are met and/or so that at least significant departures from such expectations are addressed in some manner. Thus, for example, expectations regarding targets for instruction fall through and/or for instruction jumps within code that is to be executed and/or that is being executed has been discussed. For such expectations to be met, however, may depend at least in part upon being able to check whether a particular instruction address belongs to a currently-executing function operation. Thus, for example, an implementation may include an operational check which may take a memory address location as an argument and return whether or not it belongs to the currently executing function operation. In this context, an operational check like the foregoing shall be referred to as the in_current_function check. FIG. 6 illustrates embodiment 600 of a method that employs such a check, as previously discussed.

An implementation of an in_current_function check, in an embodiment, may have instructions arranged in a contiguous block of memory address locations and the function_operation_start_address may comprise the first memory address location in that range. Nonetheless, claimed subject matter is not limited in scope in this respect. For example, as shall be described later, It is possible to implement a check without instructions being arranged in the foregoing manner.

In an embodiment, as previously illustrated, for example, a tag for a function operation may comprise a function_length_field, indicating the length of a contiguous block of memory address locations associated with the function operation that is also associated with the function operation tag. It is noted that this length may be indicated in bytes. For example, a function operation taking up all addressable memory available for RISCV64 for text would employ 32 bits to describe. However, in an alternate embodiment, fewer bits may be employed. For instance, a function operation may be a multiple of some number of bytes in size. For example, in an embodiment, granularity aspects that relate to implementation may be used in connection with a measure of size, in an embodiment.

Continuing with a non-limiting illustration, for RISCV64, no instruction can be less than 2 bytes in size. Thus, in an embodiment, function operation length might be written in 2 byte increments, allowing the length to be 31 bits in size, for example. This granularity may be increased (and the number of bits to encode length correspondingly decreased) by employing function operations that are aligned and padded to some larger granularity in size in an implementation. Likewise, a computing system implementation may, for example, designate that function operations are no more than a certain size. Such a computing system implementation, therefore, would be capable to designate a particular number of bits as dedicated to a length field for a function operation tag. Likewise, it may be convenient for a byte-addressed memory system to have a capability to convert a length to bytes. Thus, for an embodiment, a conversion of a length from so-called “bit units” to so-called “byte units” may be referred to as function_operation_length_in_bytes.

In a computing system embodiment in which instructions belonging to a function operation are arranged contiguously, memory address locations associated with the particular function operation may be described with a single range of memory address locations. For example, as an illustration, this range may be delimited with two memory addresses: a function_operation_base_address pointing to the first instruction memory address location associated with the particular function operation and a function_bound_address pointing to a memory address location just after the final memory address location associated with the particular function operation.

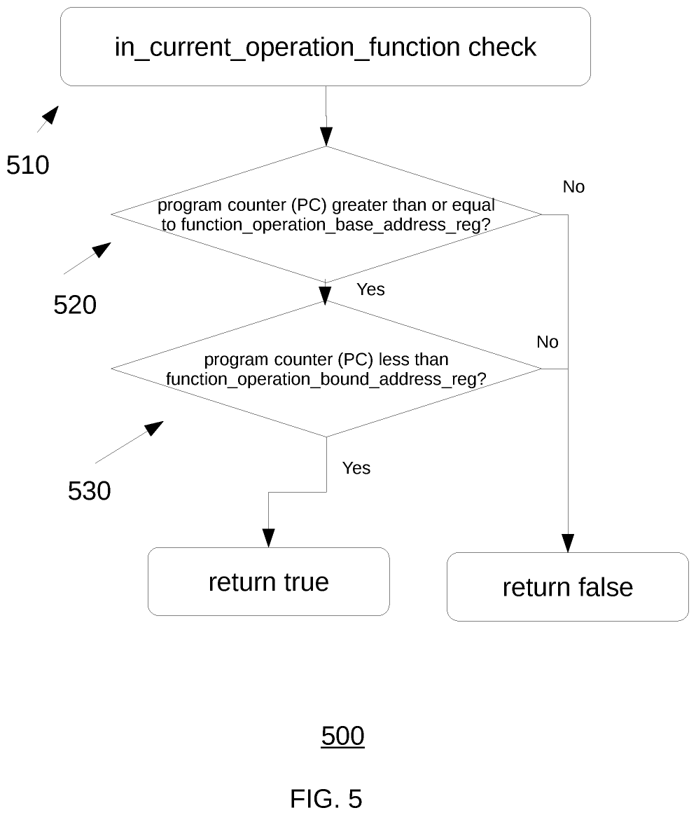

In an embodiment, to implement an in_current_function_operation check for a given memory address location, a logical value of true may be returned for a given memory address location that compares greater than or equal to a function_operation_base_address and compares less than a function_operation_bound_address, such as illustrated by example embodiment 500 shown in FIG. 5. For example, in an embodiment, for a call instruction, or for a jump instruction to the top of a formal function_operation_start_address, range delimiters may be calculated using, for the particular function operation, its function_operation_start_address as the function_operation_base_address and using, for the particular function operation, its function_operation_start_address plus the function_operation_length_in_bytes as the function_operaton_bound_address. In an embodiment, it may be desirable to dedicate two special-purpose registers, a function_operation_base_address_reg and a function_operaton_bound_address_reg, to store these values. In this manner, instances of repeat loading and calculating may be reduced. Note that, in this embodiment, function_operaton_base_address is equal to the function_operation_start_address. Thus, the value in the function_operation_base_address_reg may be used to look up function operation tags associated with the particular function operation.

As discussed above, an embodiment is illustrated for jumping or calling to a function_operation_start_address; however, the embodiment described does not necessarily address handling a jump instruction that occurs after execution of a return address for a function operation. In general, a return address for a function operation may potentially point to any memory address location of an instruction. Thus, for example, a risk exists that a jump instruction may attempt to jump within a function operation, which, as discussed, is not in accordance with conventional expectations regarding proper computing system operation.

However, a computing system in accordance with claimed subject may address this situation in an embodiment. As shall be shown at least in part by illustrations, a variety of different implementations are possible. It is intended that claimed subject matter be interpreted to cover any implementations in accordance with claimed subject matter. For example, in one embodiment, for an instruction that generates a return address into a particular operation function, one may associate with that return address the function_operation_start_address for the particular function operation. In one implementation of such an embodiment, an association may be generated by extending the value generated as a return address for a particular function operation. Thus, for example, the value may be extended to also contain the function_operation_start_address for the particular function operation. This may be possible, for example, in some architectures, without increasing the size of a machine word. For example, a return address in some architectures may not fill an entire machine word. For instance, in RISCV64, the size of a machine word is 64 bits; however, a memory address location of addressable virtual memory available for instructions may be identified with 32 bits. Typically, therefore, a memory address location storing a return address uses the 32 lowest-significance bits of the machine word to identify the return address. In such an architecture, for example, the function_operation_start_address of the particular function operation, therefore, may be stored within the top (e.g., most significant) 32 bits of the memory address location machine word that contains the return address.

A benefit is that if an instruction were to copy the contents of the memory address location in which the return address resides, likewise, along side the return address, that instruction would also copy the function_operation_start_address. Thus, for such an embodiment, the function_operation_start_address operates as an annotation able to follow the return address as it is copied to different locations in memory.

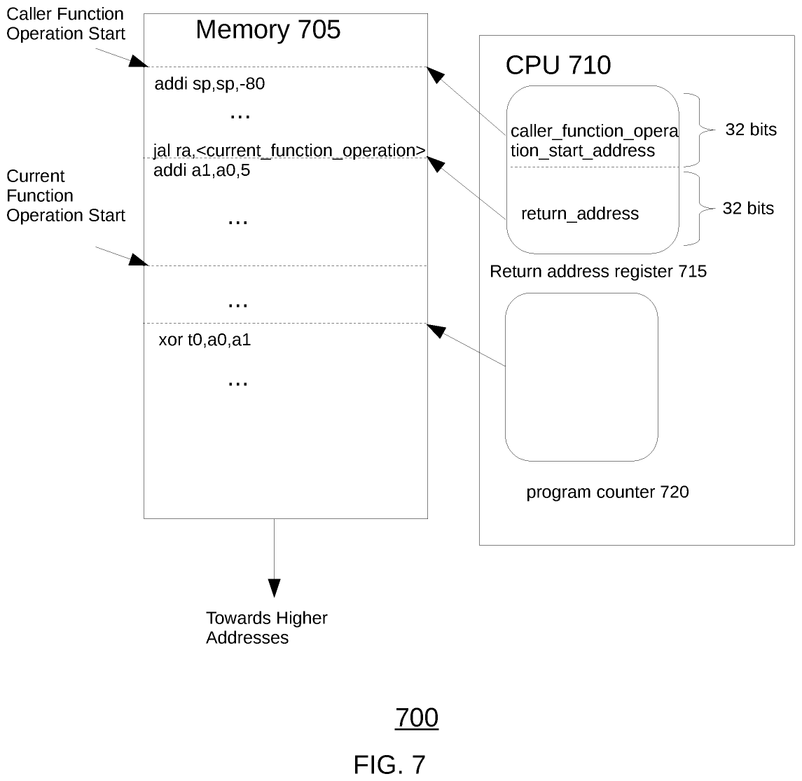

An illustrated example embodiment 700 is provided in FIG. 7. Thus, as illustrated, a processor 710 includes a program counter 720 and a return address register 715. Program counter 720 points to the memory address location in memory 705 that is currently being executed. Likewise, in this example, a caller function operation has called the current function operation, which is currently being executed. Likewise, the return address for the caller function operation is stored in return address register 715, as is the memory address location corresponding to caller_function_operation_start_address of the caller function operation.

Likewise, an alternate embodiment may identify the memory address location corresponding to a caller_function_operation_start_address for the caller function operation in a manner that employs fewer bits using a memory address location encoding mechanism, if desired. For instance, function operations that are equal to or larger than a page of memory in size may be stored in memory in a manner to align with the granularity associated with a page of memory. For example, a function operation may begin at a memory address location that corresponds to the beginning of a page of memory. Furthermore, after the end of the instructions for the function operation, which may, for example, be on the next page of memory, that page may be padded out, so that the next function operation again starts at the beginning of a page of memory.

Thus, an embodiment may employ a technique in which a location of a start address for a particular function operation is able to be determined using some form of granularity alignment related to the size of a virtual page. For such an embodiment, to provide an illustration, a page of virtual memory may have associated with it an is_large_fnop_page bit and a large_fnop_start_page_index field. Thus, for a page of virtual memory which contains instructions for a function operation that is equal to or larger than a page, the associated is_large_fnop_page bit for the page of memory may be set to true and the large_fnop_start_page_index for the page of memory may be set to the index value designating the placement of that particular page of memory out of the pages of memory for the particular function operation. Thus, with the size of a page, alignment of pages, offset within a page and the index value for a page, the function_operation_start_address is able to be determined, as described in more detail below.

For example, for an embodiment, as a result of execution of a return to a memory address location contained within a page of memory of a function operation having multiple pages of memory (or exactly a page of memory), the system is able to verify that the is_large_fnop_page bit is set to true; likewise, the system is able to generate the memory address location for the function_operation_start_address by converting the large_fnop_start_page_index field to a virtual memory address location. For function operations smaller than a page in size, the function_operation_start_address is either on the same virtual memory page as the return address or the prior page. Thus, in an embodiment, a function_operation_start_address may be encoded by an offset into the page of memory to designate the corresponding memory address location. In this context, this is referred to as the functionop_start_address_page_offset plus a bit to indicate whether it starts on the same page as the return address or the prior page. In this context, this is referred to as the prev_page bit.

In the RISCV64 case, for example, to be even more specific, a virtual memory page is 4096 bytes, which can be described in 12 bits. However, fewer bits may be used with granularity that exceeds a byte. For instance, if, in an embodiment, as previously mentioned, function operations are aligned to certain boundaries, such as a 64-bit word boundary, as an example, then a page offset can be described in 9 bits. To be more specific with this non-limiting illustration, a 64 bit word (e.g., in the form of physical signals and/or physical states) may be described using 8 8-bit bytes, in which 8 bytes is 2\hat{ }3 bytes. Likewise, a 4096 byte page is 2\hat{ }12 bytes. Thus, to describe positions on a virtual page that are aligned at 2\hat{ }3 byte boundaries (e.g., 64 bit words) instead of byte boundaries, one may describe (2\hat{ }12/2\hat{ }3) positions, or 2\hat{ }9 positions, which are able to be characterized with 9 bits.

In an embodiment, such as previously described, as an illustration, a system may set the is_large_fnop_page_bit to false for all pages containing function operations smaller than a page. For execution of a return to a return address on a page with a false is_large_fnop_page bit, the function_operation_start_address can be calculated by taking the page_index of the return address, subtracting 1 if the prev_page bit is set, then combining this page index with the function_start_address_page_offset.

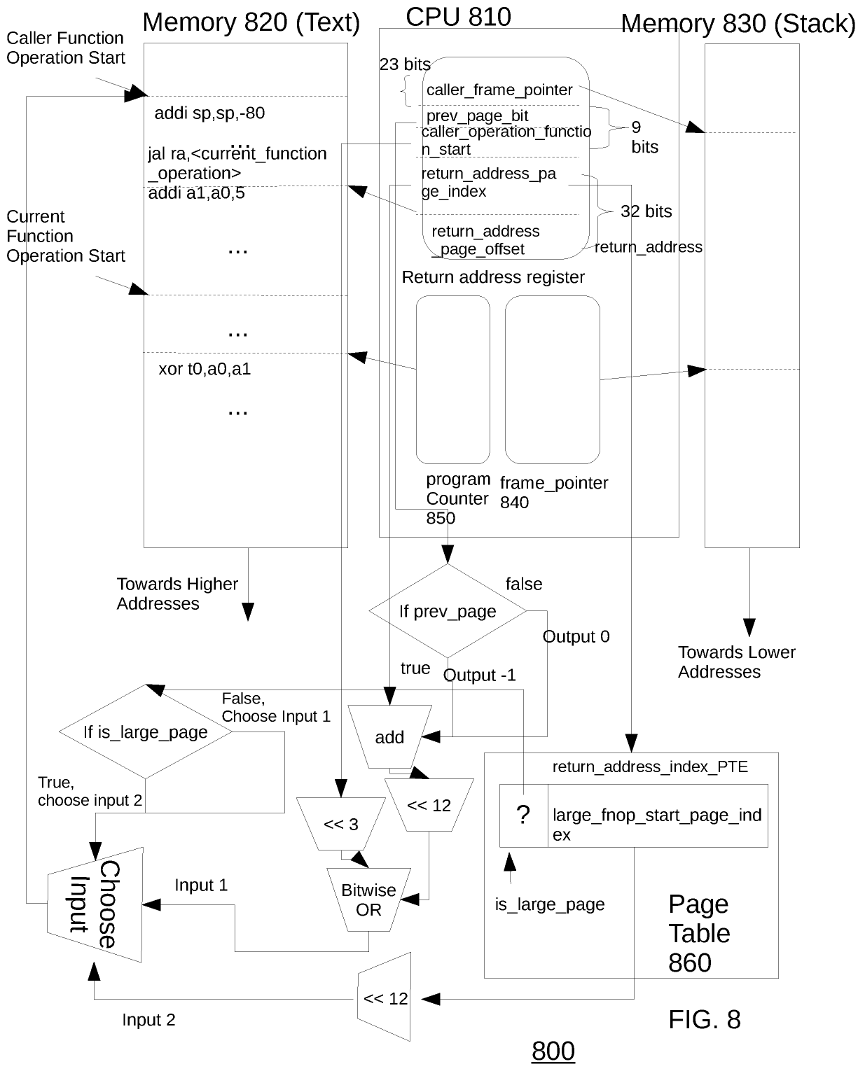

FIG. 8 provides an illustrative embodiment 800 of the approach described above. Thus, FIG. 8 shows an embodiment to decode a ret_and_frame for a traditional, page-centered virtual address space after a return in a manner so as to identify the start address of the function operation for which a return is being executed. This is desirable because the bounds of a function operation, such as its start address, is a mechanism that is able to be employed to limit potential interference with computing system operation by malware, for example. The particular embodiment is able to perform calculations in parallel for a large function operation (e.g., equal to or larger than a page) and for a small function operation (e.g., less than a page) and determine which result to use based at least in part on a virtual page table entry (PTE) and other stored signals and/or states. Thus, for a large function, that is, one equal to or larger than a page in size, such a calculation employs the page index out of the PTE and shifts it left by 12 bits. In this embodiment, function operations of size equal to or larger than a page are to be page aligned. Thus, this approach provides a mechanism to locate the start address for the function operation. Likewise, for a small function, that is, one that is smaller than a page in size, the function operation has its start address on the page containing the instruction being returned to or the page prior to that. Which page contains the start address for the particular function operation is indicated by the prev_page bit in the ret_and_frame. Thus, if the prev_page bit is false, an operation, in this embodiment, would use the same page_index as the return address of the ret_and_frame (as the function operation starts on the same page as the returned to address). If the prev_page bit is true, an operation, in this embodiment, would subtract one from the page_index shown in FIG. 8 as a choice between adding 0 or −1 to the page_index.

Thus, the page upon which the function operation starts is now known. Although there are 2\hat{ }12 addressable bytes within a page, this example embodiment has restricted functions to start at 64-bit (2\hat{ }3 byte) boundaries, meaning that there are 2\hat{ }9 64-bit boundaries within the page upon which the function operation could start. Which boundary is the start address for the particular function operation has been encoded in the 9 bit caller_function_start. Thus, use the caller_function_start and make it byte granularity by shifting it left by 3 (multiplying by 2\hat{ }3). Thus, to determine the function operation start address, an instruction, in this embodiment, may add the page-index that indicates the correct page containing the start address to the value computed by shifting the caller_function_start. However, because the portion of the address indicating the page should have all 0's in the low 12 bits, and the portion of the address indicating the offset into the page should have all 0s everywhere but the low 12 bits, thus, a bitwise-OR operation may be employed, instead, which may typically be performed more quickly than an addition operation.

The previously described embodiment allows a return address to restore the bound values of a function operation, such as a function_operation_start address, after execution of a return; however, a risk that a return address is subject to misuse/abuse via malware may remain present. More specifically, a restriction does not exist as to the value that may be used as a return address. For example, a target address that may be used as a return address may not necessarily be a memory address location that the target operation function intended to be used as a return address. Thus, for example, a “malicious callee” may return, in this manner, to be “within” a function operation that did not call it.

A desirable feature would be for a particular memory address that is to be used as a return address for a particular function operation to comprise a value generated by the particular function operation for such use. In this context, we refer to such addresses as “genuine return addresses.” To facilitate the previously described feature, in an implementation, an illustrative embodiment may introduce the notion of a “formal” pointer, and may use it to mark “genuine return addresses,” as shall be described.

For example, an embodiment may associate, with every memory word that may store a pointer in its contents, a bit indicating whether the memory word contains a formal pointer; in this context, refer to this bit as the “reference bit” and refer to a pointer that includes a reference bit as a “reference.” If the instruction set allows providing literal pointers directly in the instruction stream, it may be desirable to associate a reference bit with every memory word. For architectures that do not provide this capability (RISCV64, for instance, does not) it may be desirable to associate the reference bit with memory address locations with non-text contents. If this is the case, for an embodiment, instead, a bit in the per_word_tag_bits may be interpreted as a function_operation_start_bit or a reference_bit depending at least in part upon the value of the is_text_address predicate check.

Further, an embodiment may associate with those registers able to contain a pointer (in contrast, to memory containing a pointer), a reference bit indicating whether its contents contain a reference. Thus, to be clear, floating point registers, rounding mode control status registers (CSRs) and various other types of registers, for example, may be excluded in such an embodiment.

This may, of course, be implemented in a number of ways and claimed subject matter is intended to cover such alternatives, for example, including, but not limited, to adding an additional bit into the contents of the register (extending it from, say, 64 bits to 65 bits) or by adding an additional register containing a bit array indicating the reference bits of the other registers, where the reference bit for a particular register is stored at a particular offset into this bit array. Thus, for an embodiment, a reference bit may now follow a value as it is loaded and stored from memory via being written to or read from a register.

Further, it may be desirable for an embodiment to be able to distinguish different kinds of “formal” pointers. As described, this specific embodiment may include a formal return address; however, other kinds of “formal” pointers may be introduced into an embodiment as well, as shall be illustrated. For example, an embodiment may enumerate a number of kinds of formal pointers and associate with a machine word containing a formal pointer, a ptr_kind_enum. This association could be accomplished, in one embodiment, for instance, by providing more bits per-machine-word and per-register tag, so the tag may be used as an enumeration indicating as many formal pointers as a computing system may use, or by reserving some unused bits of the machine word containing the indicated pointer as an enumeration value indicating the kind of formal reference. In an illustrative embodiment, for example, the three most significant bits on any machine word may be reserved to annotate a formal pointer as a ptr_kind_enum. Likewise, in our example illustration, one of these enumeration values may be reserved to indicate a “formal” return address.

In an embodiment, using a formal return address, a mechanism or technique may be implemented in such an embodiment so that a return address provided by a caller function operation is not subject to modification by a callee function operation. Thus, for example, in an embodiment, a function operation may potentially be modified to generate a return address into itself as a formal return address. In RISCV64, for instance, for an embodiment of claimed subject matter, the jal instruction may be altered to place a formal return address into the link register. Likewise, a formal return address may be appropriately marked as such if made accessible to various portions of a particular architecture. This embodiment does not provide a function operation an unrestricted ability to generate a formal return address into itself; rather, the jal instruction operating within a particular function operation provides this capability. However, for another embodiment, it may be possible to provide a function operation an ability to generate a formal return address into itself, in general.

Likewise, a processor may employ additional restrictions with respect to the use of such formal return addresses in an embodiment. For example, in an implementation of an embodiment, any function operation that takes a formal return address as an input value to the function operation and calculates some result which is to be placed in a user-accessible machine word (referred to here as the “result word”) may operate in a manner so that the result word is designated as not a formal reference (e.g., via a tag), may operate to place the same inputted formal return address into the result word and mark it as formal, or otherwise issue a trap to a handler to specially handle this circumstance. In this context, the terminology “trap to a handler” or similar terminology refers to a interruption of in flow control, typically for an exceptional situation, in which the interruption transfers flow control to a specific set of instructions (e.g., code), referred to here as “a handler,” in which the specific set of instructions is provided to specifically handle the particular exceptional situation that has occurred. This approach, therefore, allows formal return addresses to be moved into different machine words of storage in a manner so that, if altered, such addresses are no longer designated as formal, or to be designated as formal, such values are not altered, despite being moved. This permits the flexibility of movement in storage while retaining the integrity of the value created.

For an embodiment, formal return addresses permit other potential safeguards to reduce potential risks associated with malware, such as risks associated with a jump instruction, for example. Thus, an embodiment may, for example, implement additional processing associated with a jump instruction. As a result of execution of a jump instruction (e.g., of any kind), a computing system, for example, may verify that at least one of the following applies to a particular situation:
1. the target memory address location comprises a formal return address;
2. the instruction stored at the target memory address location is marked as a function_operation_start_address; or
3. the is_in_current_function_check returns true for the target memory address location.
   However, if none of the foregoing apply, a trap exception, for example, may be issued, for an embodiment, so that flow control may be transferred to a handler set of instructions to address the particular exception.

Thus, in an embodiment employing such an approach, a jump that is executed within a program, that is, a jump that does not generate a trap exception to be addressed by a handler, will jump to the formally-marked “top” of a function operation, will jump to a formally-marked return address, or, after the jump, will remain within the particular function operation.

A benefit of employing an embodiment, such as previously described, is that some potential protections around instruction fall through are provided. For example, after falling through to the next instruction, the in_current_function_operation_check should remain valid. This follows from the foregoing since calls to a function operation are to the function_operation_start_address, and since execution of a jump instruction may jump to a memory address location within the bounds of the particular function operation, to the function_operation_start_address, or to the formal return address. Likewise, a jump to a function operation provides a capability to confirm or restore the memory address bounds of that function operation. In other words, in an embodiment, the bounds of the current function operation are present or easily available to be looked up or generated.

It would also be desirable if a formally-marked return address was created by a caller of a particular function operation as further protection from malware, in an embodiment, for example. Without additional processes within an embodiment of a computing system, for example, a jump through even a formal return address may not necessarily return to one of the callers of the particular function operation. Later in this document, embodiments are discussed that may include additional processes to potentially address the foregoing.

Likewise, in an embodiment, it may be desirable to perform an in_current_function check with some layout flexibility, illustrated, for example, with an embodiment described below. While having a function_operation_start_address be equivalent to a function_operation_base_address and having addresses associated with a function operation being arranged contiguously may promote performance, it may, in some situations, be desirable to employ an embodiment to provide similar protection with greater flexibility. For example, in some situations, it is conceivable a function operation may be described by an arbitrarily-sized collection of ranges of instruction addresses in situations in which addresses are not arranged contiguously. Thus, for example, a particular function operation might, in a situation, comprise sets of contiguous ranges of addresses containing instructions, although there may be addresses between the continuous ranges having contents that are not associated with the particular function operation.

Thus, for an embodiment, a function operation may include a collection of function_operation_address_ranges, in which a particular function_operation_address_range of the collection respectively comprises a function_operation_address_range_base and a function_operation_address_range_length, where the function_operation_address_range_base is equal to the address of the first instruction in a particular group of instructions of the collection associated with the particular function_operation_address_range and the function_operation_address_range_length describes the length of the particular function_operation_address_range. Although the function_operation_address_range_length may be encoded in any units, in an embodiment, it may comprise bytes, referred to, for example, as the function operation address_range_length_in_bytes. In an embodiment, a function_operation_address_range_bound, which points to the first address outside of the particular function_operation_address_range, may comprise the result of adding the function_operation_address_range_base to the function_operation_address_range_length_in_bytes. Such an embodiment may, for example, track the function_operation_start_address for the currently executing function operation in a special-purpose register, called the function_operation_start_address_reg. To accomplish an in_current_function check for a given address, such a embodiment, for example, may search the collection of function_operation_address_ranges, and return true in a situation in which, a given address, for a respective function_operation_address_range of the collection, is verified as greater than or equal to the function_operation_address_range_base and as less than the function_operation_address_range_bound. Such an embodiment comprises a generalization of the previously described embodiment which contains a single function_operation_address_range. Since, for the previously described embodiment, function_operation_address_range starts at the function_operation_start_address, storage of a function_operation_address_range_base and storage of a function_operation_start_address_range_length may be omitted. Likewise, most compilers store instructions associated with a particular function operation in contiguous blocks of instructions with their starting instruction being the function_operation_address_start, thus, the previously described embodiment should be sufficient for most computing systems.

Another desirable feature of an embodiment may relate to a technique to limit access to a stack frame from other function operations. An illustrative embodiment is now described. A computing system may include hardware and software (and also perhaps firmware), for example, so that the computing system, on a load or store, is able to relatively quickly determine whether the pointer “through” which it is loading or storing is a pointer into a memory region reserved for the stack (or not), referred to here as an is_stack_address predicate check. An is_stack_address predicate check may be implemented in a number of ways and it is intended that claimed subject matter cover a myriad of implementations.

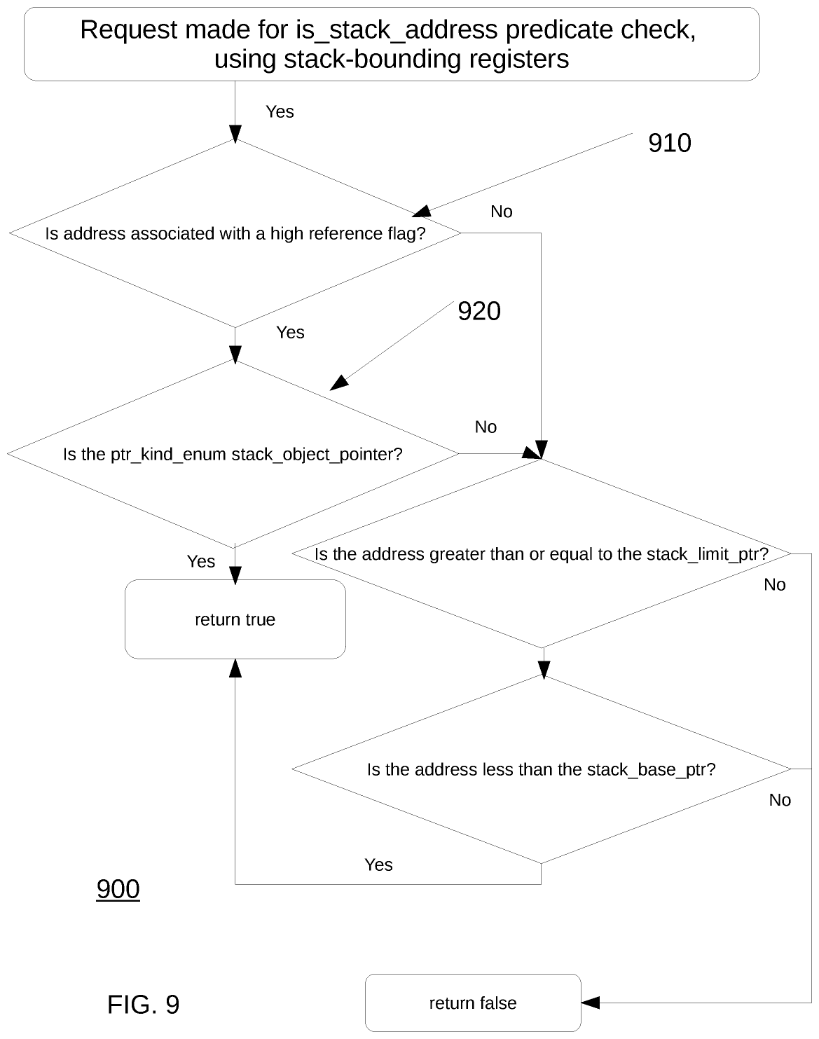

For example, in one implementation, two registers may be employed, a stack_base_ptr, pointing at the address just above the stack range of the current stack (e.g., for a particular thread), and a stack_limit_ptr, pointing at the lowest address in the stack range of the current stack. Thus, in this illustration, an is_stack_address predicate check may be accomplished so that, with memory access through a pointer, a check may be performed to verify that the start address with respect to memory access is greater than stack_limit_ptr and the highest address with respect to memory access is less than the stack_base_ptr. For example, FIG. 9 is a flowchart providing an illustration of an embodiment 900 along the lines previously described.

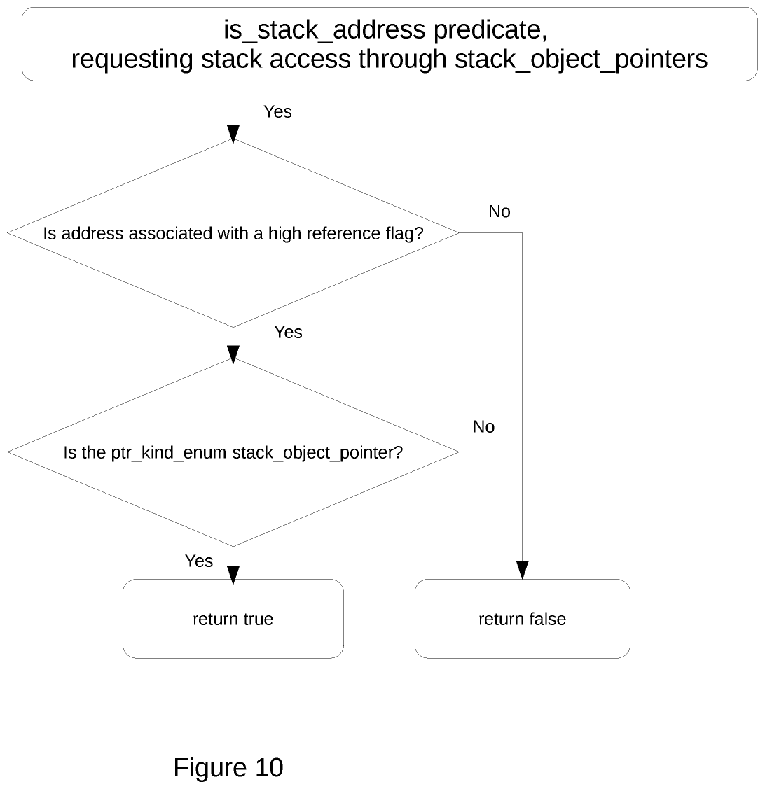

Another embodiment may indicate that a virtual page is part of a stack range by adding an is_stack_bit flag or tag to the page table entry (PTE) for virtual memory pages within the stack. Likewise, another embodiment may extend existing memory mode bits on the PTE (which may be used to indicate, for instance, whether the page is text), such as by indicating whether a virtual page is on the stack using an additional “enum” mode. In general, PTEs are consulted during a load or store to perform a translation between virtual and physical addresses. Thus, additional system operations to look up such a bit or bits on a load or store as part of an is_stack_address predicate would comprise a relatively uncomplicated system addition. Note, however, that this latter implementation of an is_stack_address predicate assumes a virtual memory translation layer. The embodiment illustrated in FIG. 9, for example, includes decision blocks 910 and 920, for such operations, which is also shown in FIG. 10 separately.

In yet another embodiment, a special-purpose processor (e.g., CPU) register called the frame_pointer may be employed. In this illustrative approach, a frame_pointer may be maintained in a manner so that it remains equal to the frame pointer for the current function operation. Thus, for this approach, a memory access may be disallowed by a computing system in situations in which an is_stack_address check returns true, but in which the highest-addressed byte accessed is greater than or equal to the frame_pointer. Later in this document, in an embodiment, this approach may be extended, as shall be further explained.

For an embodiment, to maintain the frame_pointer in the manner described above, operations associated with a call instruction may be augmented to confirm that the stack pointer (SP) is less than the current value of the frame_pointer and to set the frame_pointer equal to the current value of the SP. For a SP realized with a SP register, this may comprise, for example, copying the value in the SP register to the frame_pointer register. Also, as an aside, note that a function operation is expected to store its own return address within its own frame. However, unlike above, following execution of a call, for an embodiment of a computing system, additional processes may be employed to discover the frame pointer of the function operation to which the particular call is returning for a return being accomplished.

To accomplish this task, a formal return address may be associated in memory with the address of the frame pointer of the function operation to which it is returning. Thus, with execution of a return, the value of frame_pointer may be restored to the value of the formal return address. Although it may at first glance look as though associating this pointer with the formal return address would employ an additional 39 bits for a 39 bit address space, typical operations within the stack may decrease the number of bits to be employed.

The range of addresses reserved for a stack (e.g., with respect to a particular thread) tends to be contiguous. Also, the amount of addresses reserved for a stack tends to be small relative to size of memory altogether. For instance, on many Linux systems, the default maximum size of the stack is 8 MB in size, a space that can be byte-addressed relative to one of the ends of the stack range with 23 bits. In addition, many stacks employ frames in a manner to be aligned at particular granularities; for example, in RISCV64, frames are aligned at the granularity of 16 bytes. Such an approach would allow enumeration of possible frame boundaries in an 8 MB stack with 19 bits.

For an embodiment, an arrangement for a formal return address may consequently be discussed in terms of allocation of bits for a particular illustrative embodiment. For example, for a formal return address, 3 bits may be dedicated to identifying it as a formal return address, 9 bits may be dedicated to identifying the start address of the function operation to which the return address returns, 1 bit may be dedicated to indicate whether the start address should be considered relative to the previous page, and 32 bits may be dedicated to provide the actual return address. The foregoing arrangement leaves 19 bits unused in the formal return address, providing a sufficient allocation of bits to associate 19 bits of a frame pointer with the formal return address by storing them in the formal return address. This formal return address, augmented with a frame pointer, is referred to, for an embodiment, here, as a ret_and_frame.

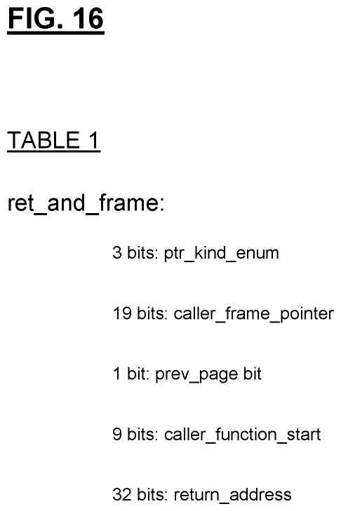

By using a frame pointer stored with respect to a formal ret_and_frame, a computing system is able to set a frame_pointer on both initiating execution of a call operation and on a return from execution of a call operation. Thus, for a computing system using such an approach, a function operation is able to restore the SP to its value at the time of call through computing system operations that, in effect, assert that, on a return, the SP is equal to the value of the frame_pointer. Also, memory accesses to the stack by such a computing system may be restricted to be to the current frame via use of an is_stack_address check in connection with a load or a store of a memory address location and via confirmation that the address is less than the frame_pointer. That is, a fault may be issued for memory accesses that do not comply with the foregoing. Thus, for an embodiment, these mechanisms may be employed to maintain system integrity in a manner so that memory accesses to the frame of a function operation are not to be made from outside of the function operation. FIG. 16 includes a table, table 1, that provides a breakdown of an embodiment of a formal return address, as previously described, for illustration purposes.

In some situations, however, it may be appropriate to permit memory access to stack objects in a manner that is legitimate, as opposed to a memory access that might take place by a malicious third party, such as via malicious code, for example. Therefore, an embodiment that permits the former while reducing the risk of the latter is described.

As mentioned before, not all memory accesses from other function operations to a frame for a particular function operation are inappropriate. For a situation in which a function operation takes the memory address location of one of its stack objects and passes this pointer to a callee, it may be desirable for a computing system to be able to allow access to this stack object through this pointer or any offsets or copies thereof until the stack object is no longer allocated (e.g., after the function operation returns from being called).

To permit a function operation to have a capability to provide memory access to objects within its particular frame, an additional “formal” pointer may be employed, referred to here as a stack_object_pointer. A stack_object_pointer in one embodiment may contain within it a pointer into the stack, a base address of the stack object, and a size. This approach bypasses managing an additional shadow stack or performing a relatively-slow heap allocation. Likewise, in an embodiment, an operation may be executed, referred to here as create_stack_object_pointer. For such embodiment, an operation may, with a start address and a size, return a stack_object_pointer with that start address and size, pointing initially at the start address, as long as the range delimited by the start address and the size falls entirely within the current stack frame. Likewise, stores to memory above the current frame pointer may be permitted for such an embodiment in those situations that occur through a valid stack_object_pointer.

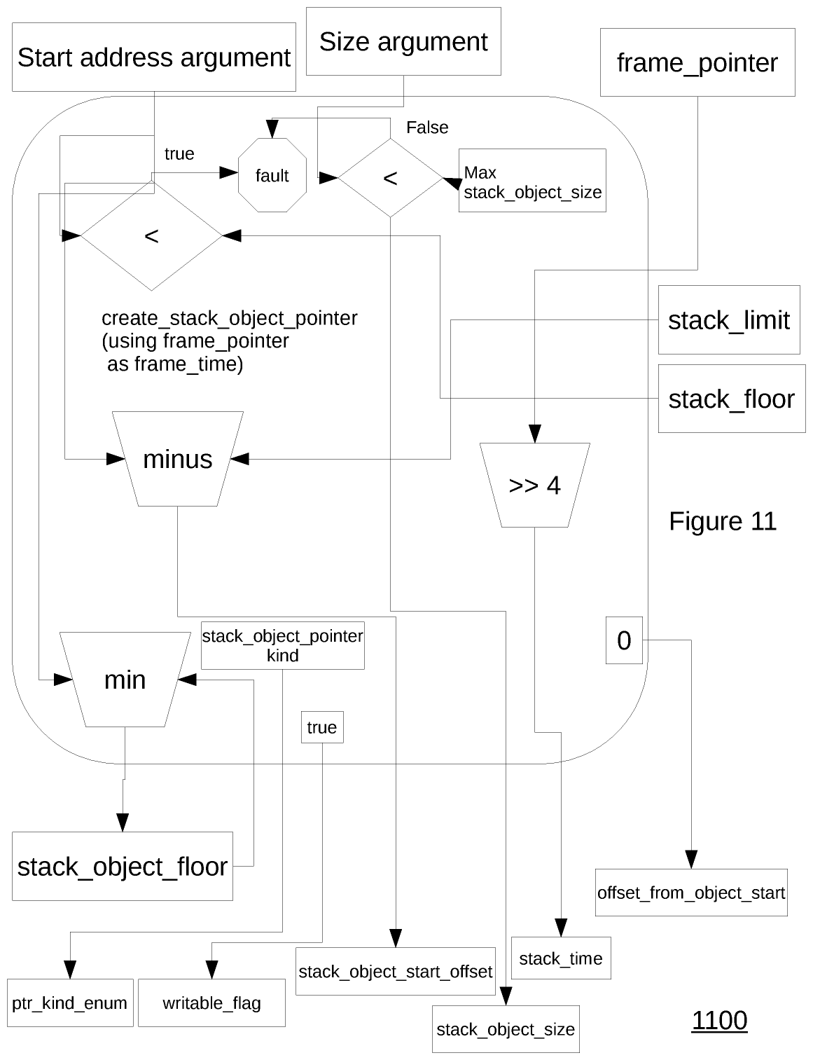

FIG. 11 provides an example of an illustrative embodiment, 1100, regarding operation of an instruction create_stack_object_pointer, as previously described. Thus, embodiment 1100 illustrates an implementation for a create_stack_object_pointer instruction, given a set of input values, for an embodiment in which frame pointer may be employed to provide a rough measure of stack time. The input values in this example fall into two categories. The first category relates to user-provided arguments, comprising the start_address argument and size argument, indicating the desired start address and size of a stack object to be crated. The second category relates to values from registers that the CPU in this embodiment is able to track for boundary monitoring, including the frame pointer (where the current frame starts on the stack), the stack_floor (the lowest address that has been written in the current frame), the stack_object_floor (the address less than or equal to that of the lowest stack object), and the stack_limit (the low address endpoint of the stack). Also a max_stack_object_size may be employed, which operates as a type of a constant value “known” by the CPU itself.

Thus, this embodiment operates as follows. After receipt of the input values, the instruction checks that the provided object size is less than the max_stack_object_size, and otherwise a fault occurs. The instruction checks that the start address argument is greater than or equal to the stack_floor, and otherwise a fault occurs. The instruction subtracts the start address from the stack_limit, producing the stack_object_start_offset. The instruction assigns the size argument to the stack_object_size. The instruction right-shifts the frame pointer by 4 (i.e., divides by 2\hat{ }4, or 16) and produces the stack time. The instruction takes the lower of the stack object start address and the current stack_object_floor and uses that value to produce it a stack_object_floor to replace the previous stack_object_floor. The instruction produces a ptr_kind_enum of stack_object_pointer “kind.” The instruction produces an object_offset of 0 and the instruction produces a writable flag of true. Of the above, the stack_object_size, stack time, stack_object_start_offset, ptr_kind_enum, object_offset, and writable_flag are all packaged up into a produced stack_object_pointer. The stack_object_floor is a separate register tracked by the CPU, as previously indicated, and its value is updated.

An embodiment, such as described above, unfortunately, may still have risk of an attack from malicious third party code. As an example, an attack might take place by a function operation establishing a stack_object_pointer with respect to some range of memory, raising the SP to that range, and executing a call operation. For example, the callee function operation may be “tricked” into using this object to overwrite it own stored contents or the pointer may be passed to a callee of the callee so that the stack_object_pointer established by the calling function operation may provide unintended memory access to the stack of a callee function operation.

This risk may potentially be addressed in an embodiment by establishing a threshold referred to here as a stack_object_floor, which may be maintained to be the lowest memory address to which a stack_object_pointer is permitted to provide access. In an embodiment, a computing system may implement this form of protection by asserting, in connection with execution of a call operation, that the SP is less than or equal to the stack_object_floor and setting the stack_object_floor to the stack pointer. Likewise, with a return from a call operation being executed, in such an embodiment, a computing system may reset the stack_object_floor to the frame_pointer. This, in effect, limits memory access in a manner so that, with respect to a caller function operation, the frame of its callee function operation is not shared, which is desirable so as to maintain frame integrity.

If, however, a function operation may generate a stack_object_pointer into its own frame and, in circumstances in which the stack_object_pointer is stored into a heap location, a global, or another “long-lived” location of a stack object, storage may be permitted to continue past the point in time at which the function operation returns. Thus, it could be possible for this stack_object_pointer to be used to perhaps perform memory accesses with respect to stored memory contents for an unrelated function operation which did not intend to share memory access to content that may be stored within addresses indicated by the stack_object_pointer. To reduce risks associated with such a possible situation, it would be desirable to have an approach so that stack_object_pointers are not extant and/or not accessible after the object to which they point has been unreserved. A set of conditions, described below, to be implemented with respect to stack_object_pointers, may be employed to reduce such risks, for an embodiment:
stack_obj_ptr_condition1: Implement a stack_object_pointer in a manner so that it will not be stored to memory outside of the particular stack;
stack_obj_ptr_condition2. Implement a stack_object_pointer in a manner so that it will not be stored into stack frames that “outlive” the object to which it points;
stack_obj_ptr_condition3. Implement a stack_object_pointer in a manner so that it will not be returned to a function operation more “caller-ward” than the function operation that generated it; and
stack_obj_ptr_condition4. Implement a stack_object_pointer in a manner so that that a function operation cannot read a stack_object_pointer left on the stack by a previously executed function operation.

In this context, the terms “outlive,” “longer lived”, “less long lived” or the like, in a situation in which, for example, two values (or similar content) may be stored in memory, in general, is employed to refer to one value continuing to reside in memory after the other value no longer resides in memory or that resides in memory that remains allocated and read-accessible longer than the other value. As a simple example, consider a pointer to an object in memory, which is stored in a location in memory, and the object itself which likewise is stored in memory. In this latter situation, “outlive” or “longer lived” refers to the pointer continuing to reside in memory after the object to which it had pointed no longer resides in memory or after the object is no longer read-accessible; whereas the object is said to be less “long lived” compared to the pointer. Likewise, in this context, the term “more caller-ward” in connection with a particular function operation refers to a function operation that was a caller of the function operation, or that was a caller of the caller of the function operation, or that was a caller of a caller of the caller of the function operation, etc. By implementing the conditions above with respect to a stack_object_pointer and implementing a register calling convention, to be discussed in more detail below, for such an embodiment, for example, a stack_object_pointer should not be usable after the function operation into which it points has returned.

To implement stack_obj_ptr_condition1, in an illustrative embodiment, for example, a computing system may be implemented to fault in a situation in which a store is executed, the value being stored comprising a stack_object_pointer, and the address selected for storing the value after an is_stack_address predicate check does not return as true.

A store into the current frame, of course, would comply with stack_obj_ptr_condition2. In this context, “current” as used in “current frame,” refers to a frame for a currently executing function operation. More specifically, with respect to stack_obj_ptr_condition2, in a situation in which a stack object points to the current frame or a more “caller-ward” frame, storing to the current frame is allowed. A stack object associated with respect to a less “long-lived” frame should not have been made available to the function operation associated with the current frame. It is noted, as previously discussed, for an embodiment, however, writing to the stack outside the current frame is allowed through stack_object_pointers. Thus, stack_obj_ptr_condition2 may be implemented for an embodiment by implementing a stack_object_pointer in a manner so that it would not be stored through a stack_object_pointer to a “longer-lived” frame. Thus, an aspect of implementing stack_obj_ptr_condition2 involves formulating an approach to measure relative longevity with respect to frames pointed “into” by stack_object_pointers

One approach to such a measurement, for an embodiment, involves making use of relative addresses of frames on the stack. That is, relative addresses provide at least a rough indication of relative longevity. Frames associated with more-recently-called function operations tend to be located at lower addresses than frames for less recently called function operations, using the convention previously discussed regarding memory address ranges in which it is assumed that such ranges start at a numerically higher memory address. Of course, claimed subject matter is not so limited and an embodiment may be adjusted for a situation that employs a convention in which ranges start at a numerically lower address. Continuing with this embodiment, however, in a situation in which frames are unreserved in a conventional fashion, function operations associated with lower addressed frames will also tend to return and unreserve those frames earlier than function operations associated with higher addressed frames in accordance with the previously assumed convention regarding memory address ranges.

Thus, in an embodiment, a canonical representative address may be employed to generate a stack_object_pointer in a manner so that this address would not be used with respect to another frame. Likewise, in an embodiment, that representative address may be used to annotate a stack_object_pointer generated in a manner so that these addresses may be employed to compare longevity of pointed-to frames. For an embodiment, this representative address may be annotated with respect to a stack_object_pointer and, in this context, is referred to as stack_time.

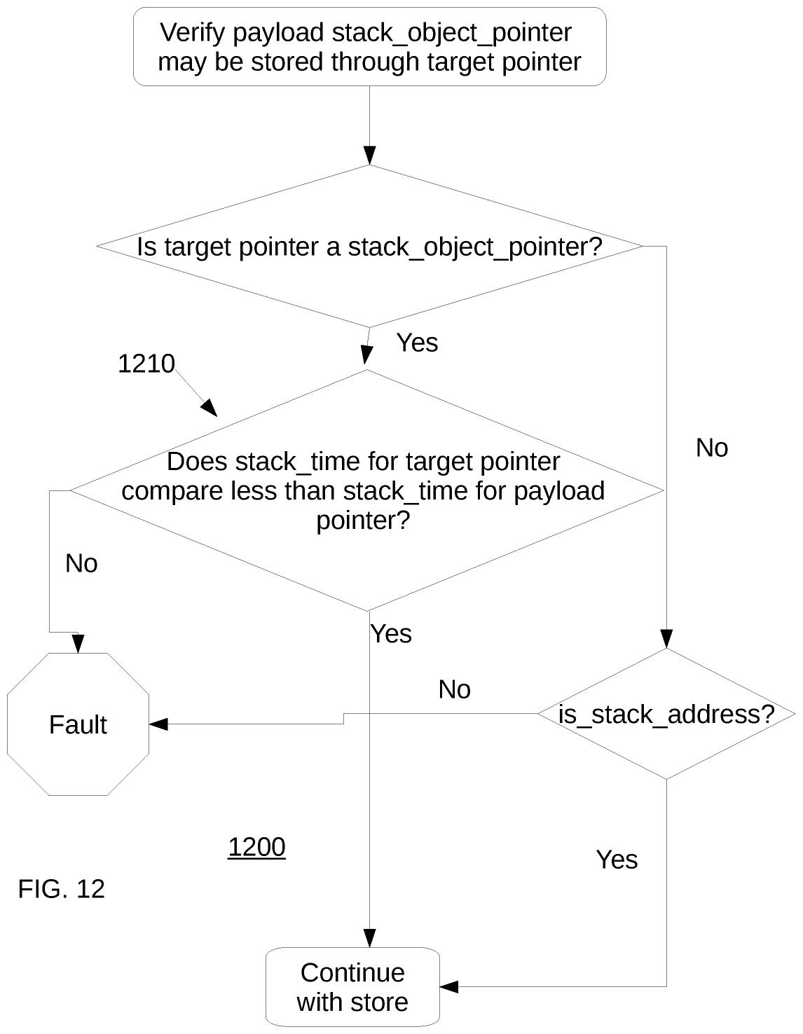

One possible address to choose as a proxy for longevity, which may, therefore be employed as stack_time, for an embodiment, is the value of the frame_pointer register. A computing system, such as has been described, maintains a frame_pointer register to comprise a value just off the end of the current frame. Likewise, typically, such as previously described, it is stored in a special register and, thus, typically, should be system-wide accessible with ease. For an 8 MB frame on a RISCV64-type computing system, for example, 19 bits may be used to indicate this value. Thus, within a computing system, in an embodiment, as an illustration, for a situation involving storing a stack_object_pointer through another stack_object_pointer, the computing system may verify that stack_time of a stack_object_pointer to be stored is greater than a stack_time of a stack_object_pointer being “stored through,” so to speak; otherwise, a computing system may not permit the store, may issue a fault, etc. FIG. 12 is a flowchart illustrating an example of an embodiment 1200 in which stack_obj_ptr_condition1 and stack_obj_ptr_condition2, as previously described, for example, may be checked with respect to execution of a store involving a stack_object_pointer. Thus, block 1210 compares stack_time of a stack_object_pointer for a target function operation with stack_time of a stack object_object_pointer for a current (e.g., payload) function operation.

For an embodiment, stack_obj_ptr_condition3 may be implemented via a check so that a stack_object_pointer is not returned to a frame more caller-ward than the frame for the stack object to which it points. For example, in a typical computing system, return values may be passed through so-called caller-save registers. As an illustration, RISCV64, for instance, does this.

In an embodiment, an operation, referred to here as check_ok_to_return, may be implemented. In conjunction with implementation of such an operation, for example, an embodiment may associate with a register an ok_to_return flag, which by default may be set to false. A check_ok_to_return operation, in an embodiment, may provide an input register address and an output register address. The check_ok_to_return operation may read the value from the input register and may run a predicate on it, which is referred to here as the ok_to_return_predicate. If the ok_to_return_predicate evaluates as true, the value stored in the input register may be written to the output register and the ok_to_return flag for the output register may be set to true. If the ok_to_return_predicate evaluates as false, the check_ok_to_return operation should fault or write the value stored in the input register to the output register and set the ok_to_return_flag on the ouput register to false. That is, for this embodiment, the check returns true if the value being returned is not restricted by stack_time (e.g., is a merely a stored value, or a pointer other than a stack pointer) or if the stack time of the value is as long lived or longer than the frame to which a return is being made. If a return operation may only return to the function operation that called it, this may be performed simply by checking that the stack_object_pointer being returned has a stack_time longer lived than the current function. If an embodiment were to permit a return to the calling function or any more caller-ward function (which may possibly useful for implementing, say, C++ exceptions, for example) then a more complex approach may be desirable, such as, for example, annotation of the stack_time of the function operation to which a return is being executed, such as was discussed previously for an embodiment with respect to ret_and_frame. Thus, in an embodiment, for example, a return instruction may be augmented to include the foregoing operation for values to be returned and augmented to clear a caller-save register that does not have an ok_to_return_flag set to true. Thus, by a restriction with respect to return values that have been marked ok_to_return, genuine references that did not pass the ok_to_return predicate will not be passed via a return to an unintended context.

However, instead, for a computing system, for example, as an alternative implementation, reference flags may be realized by storing them in a reference flag register that acts as a bitfield, with respective bit positions in the latter register indicating a reference flag for an associated other register. Likewise, in such an implementation, a computing system may implement ok_to_return flags in a similar manner. A clearing operation, as described above, may be executed in such an implementation by performing a bitwise comparison between these two registers and storing the result in the reference flag register. Thus, the ok_to_return register contains a set bit in a position for an associated register after a return if the reference flag register had the corresponding reference flag set before the return and the check_ok_to_return operation was executed with respect to the associated register and the ok_to_return predicate passed. Modern processors contain circuitry able to perform this AND operation on all corresponding bits of two registers, quickly providing a result register value containing, in this example, a 64 bit-width result. By placing the ok_to_return flags and reference flags in two registers in this fashion, performing an AND operation between the ok_to_return flags and the reference flags, and writing the results back into the reference flag register accomplishes quickly clearing the reference flags using the ok_to_return flags. A distinction, it is noted, is made above, between caller-save registers and callee-save registers in describing an example implementation. Likewise, for the implementation of the prior paragraph, making a similar distinction between caller-save and callee-save registers, it may be possible to use callee-save registers rather than caller-save registers. For example, an embodiment may not write to (or clear) a caller-save register in light of an associated flag indicating false or an embodiment may write to a callee-save register and set an associated flag to false indicating a value is not ok to return.

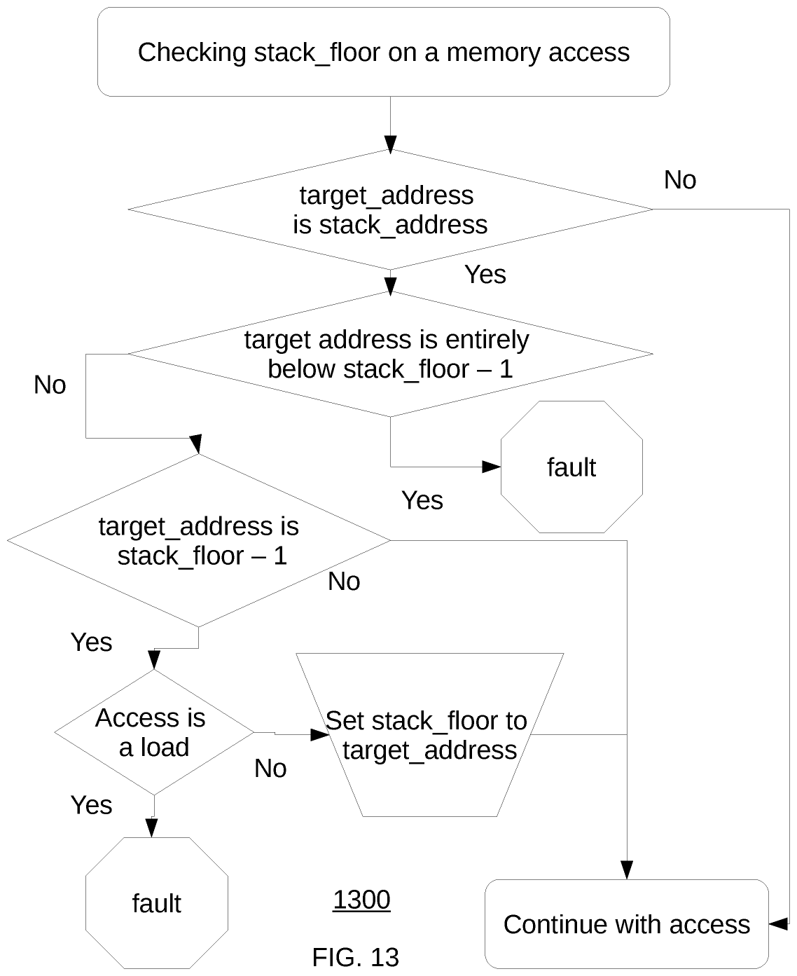

A variety of differing approaches to implement stack_obj_ptr_condition4 are possible and it is intended that claimed subject matter include those differing approaches. As one illustrative example, a function operation may initialize memory locations with respect to its stack frame before reading from those memory locations. Likewise, in such an implementation, a computing system may track a memory location threshold referred to here as a stack_floor, where the stack_floor points at the lowest initialized stack address. Thus, for a computing system to read from a memory address location on the stack, in an embodiment, the address of that memory location shall be at or above the stack floor, otherwise resulting in a fault. Likewise, for a computing system, a write operation to a memory address location of the stack may be executed. In many architectures, however, a write operation may be of many different sizes—in RISCV64, it may be of size 1 byte, 2 bytes, 4 bytes, or 8 bytes. Thus, in an embodiment, any write operation which writes a contiguous collection of bytes including the byte directly before the stack_floor results in the stack_floor being lowered to the lowest byte in that range. FIG. 13 illustrates an embodiment 1300, as previously described above, regarding use of a stack_floor in connection with memory accesses.

Likewise, in an implementation, with respect to a call to another function operation, the stack_floor may be set equal to a value stored by the SP register. In this manner, the stack_floor may be reset to the value in the frame_pointer register with respect to a return rather than tracking an additional state indicating how much of the previous frame had been written to, so to speak.

It is also desired in an implementation that a function operation not share access to a stack object containing uninitialized memory with respect to another function operation. Thus, a stack_object_floor may be tracked, which, for an embodiment, may be the lowest address at which the current frame has created a stack object (or the frame pointer if no stack object has been created). Likewise, the stack_floor may be lowered to the lowest of stack_object_floor and the stack pointer before a call. In this manner, for an implementation, a stack address will not be read before it is written; likewise, the number of writes to initialize the stack may also be reduced, as a compiler is able to arrange writes to perform the task to lower the stack floor. For such a system implementation as the foregoing, tracking the stack_object_floor and the stack_floor involves a comparison against both thresholds on a call to verify that the contents of SP is less than or equal to the stack_object_floor but greater than or equal to the stack_floor. Thus, for an implementation, if desired, the two thresholds may be combined into one stack_threshold pointer. The stack_threshold, in this embodiment, is lowered by conditions that would lower the stack_floor, and stack objects are created to be entirely above the stack floor. Similar check verifications may be made in connection with stack_object_pointer creation, stack accesses, and calls. For calls, in an implementation, for example, the combination of the two thresholds is employed so that a SP is set equal to the stack floor on execution of a call.

Another approach to implement stack_obj_ptr_condition4 is to perform a static analysis on assembly code associated with one or more function operations to determine that a stack address is not read before it is written. This static analysis could be performed during loading of a function operation, for example. For a static analysis that is indeterminate with respect to whether a function operation does not read an uninitialized word from the stack, the system may fault or may execute code to pre-initialize the stack. For an operating system designed to monitor such verifications, an executable containing function operations that have passed this check may include a stored flag or tag with this indication; thus, on a load, a re-verification may be omitted. While a static-analysis implementation approach may complicate the loader, it likewise may reduce the amount of mechanism implemented by other parts of a computing system, which may, for example, reduce a burden on a hardware component of a computing system, such as a microprocessor, for example.

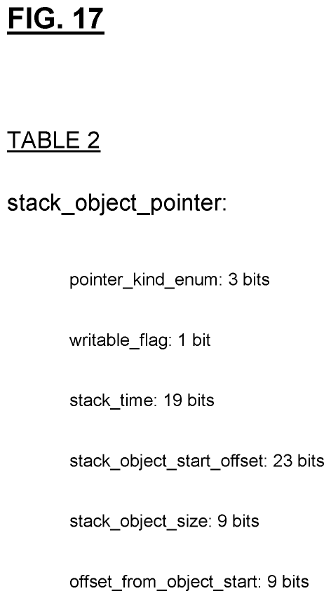

For an implementation including a mechanism for stack_object_pointers (e.g., as previously described), an illustrative example layout for a stack_object_pointer for an 8 MB stack on a RISCV64 machine is provided in Table 2 of FIG. 17. In the example layout of Table 2, the stack_object_start is indicated as a 23 bit offset from the low-addressed end of the stack range, while the address pointed to is provided as an offset from the start of the stack object. In connection with loading or storing through a stack_object_pointer, the memory address being accessed may be determined by adding the stack_limit_ptr, the stack_object_start_offset, and the offset_from_object_start. For access of memory taking place through a stack_object_pointer, a system verification may include that the offset_from_object_start is less than the stack_object_size or else a fault may occur. In connection with performing operations related to a stack object, addition or subtraction to this pointer may be performed directly on the offset_from_object_start; however, in a situation in which an operation involving offset_from_object_start overflows or underflows its unsigned 9 bit integer range, a fault may be generated.

The illustrative implementation above relates to stack objects that are less than 512 bytes in size. Stack objects larger than this may be moved to the heap and deleted at the end of a function operation call. It is noted moving stack objects above some size threshold to the heap is a conventional operation in connection with state of the art compliers. However, it may be desirable in an alternate implementation to increase permissible sizes for stack objects before resorting to employing heap-type operations. One benefit may be reduction in use of heap-type operations, which may otherwise be a computing system burden (e.g., potentially with respect to speed of execution).

In an embodiment, larger stack_object_pointers may be employed via a more efficient approach to representing so-called stack time. In a previously discussed embodiment, a frame_pointer was employed as a technique to at least roughly (e.g., adequately) provide a measure referred as stack_time. However, given the nature of a stack and a frame, any address in the frame may be employed and provide an adequate approach to represent stack_time, which, again, provides an adequate, but rough, so to speak, measure. Thus, in an alternative embodiment, a stack limit offset that has trailing 0s and falls within or just after the current frame may be employed as a type of stack time measure. A desirable aspect of such an address includes an ability to generate a compressed representation such that, in this situation, higher bits of the address provide values of greater use. To find such an address, in an implementation, as an example, perform the following:
1. subtract the value of the stack pointer (SP) register from the value in the frame_pointer register, providing the frame_size;
2. calculate the base 2 logarithm of the frame_size, providing the log 2_frame_size; and
3. Round the value of the frame_pointer register down to a multiple of 2 raised to the power log 2_frame_size.
   In this illustrative embodiment, this result is referred to as the frame_pivot.

The log 2_frame_size is less than or equal to the frame_size. Furthermore, the address range of the frame includes a multiple of the log 2_frame_size. Thus, by construction, any address in the frame is capable of being expressed as an offset from the frame_pivot using a signed offset with log 2_frame_size+1 bits. In the foregoing manner, the lower log 2_frame_size_bits for a frame pointer have been omitted; thus, for an 8 MB frame, expressing the frame pointer in (23 bits minus the value of log 2_frame_size). Similarly, by expressing the offset to the current SP in log 2_frame_size+1 bits, both the frame_pivot and the offset to the current SP within the stack object are expressible with 24 bits. However, it is desirable to demarcate the frame pivot bits from the offset bits. This is possible with the log 2_frame_size, employing an additional 5 bits (e.g., the base 2 logarithm of 24 rounded up is 5).

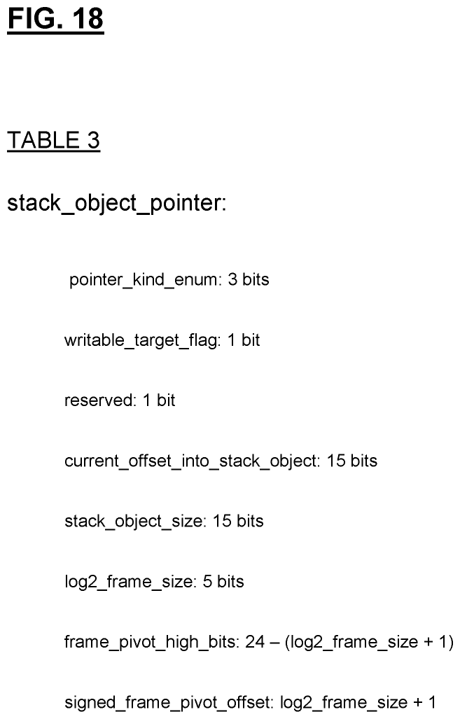

Thus, for an embodiment, a stack_object_pointer laid out as shown in table 3 of FIG. 18 provides an illustration. A stack_object_pointer up to (1<<) 15 bytes, or 32 KB in size is capable of being expressed. Note that “<<”, such as used in the foregoing sentence and elsewhere in this document, denotes a “left shift” or essentially moving a binary value to a higher order of magnitude. For example, if x is left shifted by y, denoted x<<y, this is equivalent to x being multiplied by 2\hat{ }y. Likewise, this approach may be employed as a pointer into the stack using the following relationship:

stack_limit_ptr+frame_pivot_high_bits(<<log 2_frame_size)+signed_frame_pivot_offset

Any addition or subtraction to the stack_object_pointer would involve altering both the signed_frame_pivot_offset and the offset_into_stack_object. Likewise, a computing system fault should occur in situations in which the offset_into_stack_object overflows or underflows its 15 bit value or in which the signed_frame_pivot offset overflows or underflows its signed (log 2_frame_size+1) bit value.

Operations described above involve translation between a pivot-type stack_object_pointer and an address. In an embodiment, however, the amount of times this translation might occur may be reduced. For example, in an embodiment, a special virtually-addressed L1 cache may be employed specifically for the stack with memory addresses within the cache provided using the frame_pivot_offset_num_bits, the frame_pivot_high_bits, and the signed_frame_pivot_offset, such as in accordance with the manner previously described, for example, and explained in more detail below.

While L1 caches are typically virtually-indexed and physically-tagged to detect virtual mapping aliases and to allow receiving messages from a cache coherency protocol, these concerns are generally not an issue here, for this particular embodiment, in connection with use of a stack. A stack is nearly (and can be made to be entirely) “thread-local,” so to speak. Thus, addresses to be handled (e.g., such as described below) do not relate to a cache coherency protocol. Likewise, from a software perspective of a computing system, an operating system need not produce a mapping alias in the stack range to reduce risk of these addresses being associated with a cache coherency protocol.

Nonetheless, use of a “signed” offset may make “hitting” such a cache awkward, however; in an embodiment, instead, a frame pivot offset may be expressed as an unsigned binary value using a bias upwards by (1<<) log 2_frame_size. This may be implemented with an additional subtraction of (1<<) log 2_frame_size on the far end of the cache, but has a benefit of otherwise simplifying overflow detection on the front end of the cache, in an embodiment. For example, an overflow of the offset bits may be detected by verifying that the bits of the stack_object_pointer are equal before and after addition (except for the frame_pivot_offset bits).

For an embodiment, to accomplish the foregoing, accesses to the stack should occur through stack_object_pointers. In an embodiment, to accomplish this, another type of “whole-frame” stack_object_pointer may be employed and the manner of raising and lowering the stack pointer is likewise altered so that this type of stack pointer (SP) is made to be “frame_pivot oriented,” as discussed in more detail below.

Thus, for an embodiment, frames that are to be on the stack have a maximum frame size that is to be known for a particular computing system at compile time. This is generally the case for stack frames of function operations written in C, as an example, with two exceptions: stack local variable length arrays and space allocated with alloca. Thus, for convenience of implementation, these may be omitted or otherwise may be handled via use of the heap, so to speak.

An additional bit to differentiate “whole-frame pointers” from the type of “restricted” pointers, as discussed in previous embodiments, although possible, may be omitted. Instead, to express a whole-frame stack object, in an embodiment, stack_object_size may be set to 0 and current_offset_into_stack_object may be set to higher bits of the value for current_offset_into_stack_object (e.g., such as discussed previously with respect to the frame_pivot).

For an embodiment, a computing system may operate in a manner to ignore a current_offset_into_stack_object and stack_object_size during additions and bound checks for a whole-frame stack object, for example. Likewise, for an embodiment, a loader may initialize a SP with a whole-frame stack_object_pointer using a frame_pivot appropriate for the frame of an initial function operation, (for example, here, referred to as “start”). Likewise, to “dereference” a whole-frame stack_object_pointer, a computing system, for an embodiment, may assert a frame pivot for a stack frame, for the function operation corresponding to the whole-frame stack_object_pointer being dereferenced, to be below or equal to the frame pointer. For an implementation to accomplish the foregoing, for an embodiment, a callee, for example, that “inherits” an SP value oriented around its caller's frame_pivot (and thus having a frame_pivot above SP) may re-orient the value in SP around the frame_pivot of the callee.

For example, for an embodiment, an operation referred to here as reorient_whole_stack_object_pointer may use a log 2_frame_size value provided to it and produce a whole-frame stack_object_pointer pointing at the current frame_pointer (e.g., for the currently executing function operation). Likewise, for an embodiment, such an operation may also lower the stack_object_floor or stack floor to the frame_pivot minus one so as not to overlap with an existing callee frame (which otherwise might “collide” from such an overlap). Likewise, with a return to the caller function operation, the caller function operation should reorient the SP relative to its own frame_pointer so as to access its own stack space.

It is desirable to have a technique so that such an operation does not reset its frame_pivot to multiple different values, which would produce equivalent cache entries to the same addresses. In one embodiment, for example, a computing system may track a Boolean valued flag called frame_pivot_already_set. With execution of a call operation, for example, this may be set to false. Likewise, with a call to reorient_whole_stack_object_pointer or with a return, this flag may be set to true. Likewise, in an embodiment a call to reorient_whole_stack_object_pointer may be performed in a situation in which the frame_pivot_already_set is false, or in a situation in which the frame_pointer minus the stack_object_floor has the same base 2 logarithm as the provided log 2_frame_size (which, in effect, allows “reorienting” after a return).

For an embodiment as described above, memory accesses to the stack may be performed through stack_object_pointers; however, the possibly-slow translation of a stack_object_pointer to a conventional memory address representation may be performed during the fill operation of the L1 stack cache, which is a standard computing system operation. As an additional benefit, the is_in_stack predicate, discussed previously with an example implementation may be simplified in an embodiment as a verification that an address has a formal stack_object_pointer (see, as an example illustration, FIG. 10); this, of course, likewise assumes a verification occurs on the fill of the L1 cache that the address being accessed falls within the stack range so that a stack_object_pointer is not available for memory accesses outside of the stack.

In an embodiment, it would also be desirable to retain compatibility for various existing call conventions. Such an embodiment may reduce overhead for re-engineering and/or re-design, such as in connection with pre-existing code, for example. One such convention would be to permit so-called callee-save registers. An example embodiment to accomplish this is described below.

Mechanisms discussed so far have spoken a great deal about restricting access to memory; however, so far, not much has specifically addressed restricting access to registers. Registers typically are special storage locations directly on a CPU and typically are distinct from memory in a few ways. A register is typically not described by an address. Rather, a register is typically described via a name (such as a0, ra, sp, etc) directly encoded into an instruction. Registers also typically do not take up space in a virtual or physical address space. Thus, registers are often implemented with a fast, small, on-chip storage system that, however, may look somewhat like a CPU-private version of main memory called the “register file.” Thus, while registers may “look” somewhat like memory, registers typically do not participate in the same space as regular memory and are typically not just reserved pieces of regular memory. Previously, the notion of callee-save registers and caller-save registers was mentioned. In the case of caller-save registers, as has been discussed, it is desirable that no stack_object_pointer persist in memory longer than the object to which it points. That is, the pointer should not exist in memory after the object no longer exists in memory.

However, unlike caller-save registers, callee-save registers are expected to have their values be the same before and after a call to another function operation. While a callee may satisfy this convention by simply not altering the value in a callee-save register, callees also, by convention, are able to store values associated with a caller on its stack in order to restore those values before a return. A malicious callee may therefore “steal” a stack_object_pointer (or other stored caller value) about a caller that happened to be stored in a callee-save register. In addition, a malicious callee may create a stack_object_pointer to its own stack space and store this stack_object_pointer into a callee-save register, hoping that another malicious callee may later use this to get unintended access to the stack range, for example.

One possible approach would be to “defeat” the callee-save mechanism (for instance, the GNU compiler collection (GCC)-fcall-used-{regname} option may be used to make all callee-save registers to be caller-save). However, a potential disadvantage of such an approach may include an increase in additional “stack traffic,” so to speak, at least for calls involving leaf function operations (e.g., function operations which do not, in turn, call other function operations), as defeated callee-save registers for such leaf function operations, should be saved and eventually restored. Instead, it would be desirable for an approach in which callee-save registers are saved and restored as expected by existing calling conventions, but without an associated risk, as discussed above, regarding exploitation thereof by a malicious third-party. Below is described an embodiment that may be employed in this respect.

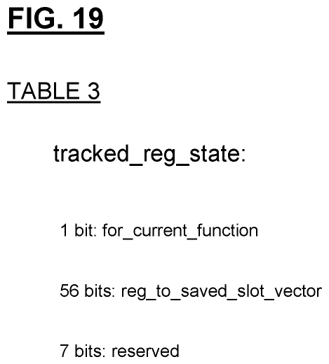

For an embodiment, for example, values for use to correspond to tracked registers may be saved in a compact vector directly below the frame pointer (GCC, for example, currently stores callee-save registers and RA in this fashion). This approach has a benefit of reducing the number of bits employed to indicate where a callee-save register is saved on the stack, as shall become clear. Likewise, in an embodiment, a CPU register referred to as tracked_reg_state may be employed. For a register 64 bits in size (e.g., wide), an embodiment of a layout for such a register is shown in table 4 of FIG. 19.

Likewise, for this illustrative embodiment, an identifier may be assigned to the callee-save registers in a compact fashion starting from 0 (e.g., s0 is 0, s1 is 1, etc.). Two additional identifiers may also be reserved, one for the tracked_reg_state of the caller and one for the return address (RA) register (which, despite generally being a caller-save register, for proper operation should be restored to its original value before a return, as would occur for a callee-save register). For example, this group of callee-save registers plus RA and the tracked_reg_state of the caller may be referred to as tracked registers. These identifiers for this embodiment, for example, may be used to index a corresponding 4 bit slot within a reg_to_saved_slot vector of the tracked_reg_state; respective 4 bit slots shall, in such an embodiment, be considered to correspond to locations within the current frame starting with the highest register address within the current frame, indicating the location at which register contents were saved.

A particular value held for a slot within the vector, in an embodiment, may be understood to mean that the corresponding register has not had its contents saved. For example, in an embodiment, all the bits may be set to 1 as an indication that the register corresponding to the particular slot has not had its contents saved. This value is referred to here, in this illustration, as the unsaved_value. For RISCV64, which has 12 callee-save registers, 14 slots may be employed to track the so-called tracked registers, or 56 bits of the reg_to_saved_slot_vector, previously mentioned.

A memory address location within the stack may have associated with it a per_word_tag_bit called tracked_register_saved_flag. The flag in this example is by default 0, indicating that the particular associated memory word stores a value relating to a tracked register. If this flag is high, any memory write to that address, in such an embodiment, produces a fault, unless the address is below the stack_floor, in which case the flag is to be lowered. If this flag is high, any normal memory read from that address, in such an embodiment, produces a fault. This illustrative embodiment also includes two operations, referred to as save_tracked_reg_state and restore_tracked_reg_state, respectively described below. These operations receive a word which designates a slot corresponding to a memory location in the current frame in the manner described above for the tracked registers.

In an embodiment, execution of the operation save_tracked_reg_state results in the following: The operation sets the for_current_function_operation flag false for the tracked_reg_state. The operation verifies the tracked_register_saved flag on the indicated memory word is low and the memory word is above the stack_floor or that the memory word is just below the stack floor. The operation saves the current value of the tracked_reg_state at the memory location on the frame previously mentioned above. The operation replaces the contents of the tracked_reg_state register with contents in which the for_current_function_operation flag is set to true and all reg_to_saved_slot_vector entries are set to unsaved_value. The operation sets the reg_to_saved_slot_vector entry corresponding to the tracked_reg_state of the caller to the appropriate slot. The operation sets the entry in the reg_to_save_slot_vector to the provided 4 bit offset. The operation clears the reference flag on the corresponding tracked register (this is sufficient to address so-called leaking references; optionally, the contents of the register may be cleared as well to address leaking).

In an embodiment, execution of the operation restore_tracked_reg_state results in the following: The operation sets the for_current_function_operation flag true on the tracked_reg_state. The operation verifies that the indicated memory word is above the stack floor and has the tracked_reg_state flag for the indicated memory word set to true. The operation verifies that the entry in the reg_to_save_slot_vector corresponding with the given tracked register is equal to the given slot offset. The operation loads the value at the indicated memory word into the appropriate tracked register. The operation sets the entry in the reg_to_save_slot_vector corresponding with the appropriate tracked register to the unsaved_value.

For this embodiment, a fault may occur in a situation in which a write to a tracked register is attempted with the tracked_reg_state storing a clear for this_function_operation flag. Likewise, a fault may occur in the situation in which the entry in the reg_to_save_slot_vector is unsaved_value. A fault may also occur in a situation in which a read from a callee-save register is attempted with the tracked_reg_state storing a clear for_this_function_operation flag. Likewise, a fault may occur in the situation in which the entry in the reg_to_save_slot_vector is unsaved_value. Here, exclusion of RA for this illustrative embodiment permits a read of RA after it has been restored.

After a call to another function operation, an embodiment may verify that the for_this_function_operation flag on the tracked_reg_state is true and set it to false. After a return, an embodiment may verify that the for_this_function_operation flag on the tracked_reg_state is false and set it to true.

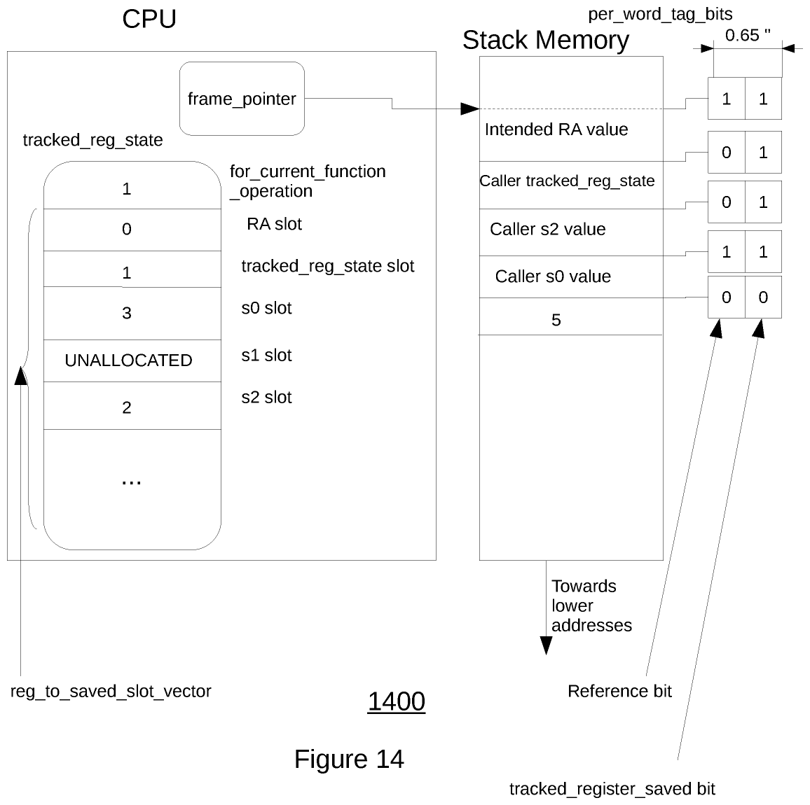

The foregoing embodiment of a function operation reduces risks of a function operation reading the values that its caller placed inside callee-save registers, while providing a way to save and restore them. Likewise, for the foregoing embodiment, for a function operation that employs a tracked register, a tracked_reg_state for the caller is saved and the initial value in the tracked register before using it is saved and then to restored the initial value before returning. FIG. 14 is an illustration providing one example embodiment 1400 of an implementation of tracked_reg_state while in a for_current_state and of the stack range it annotates.

Note that by tracking RA in this fashion an embodiment is able to reduce risk of using an incorrect return address for a function operation. The RA register in the foregoing embodiment may be saved on the stack, in a memory word that becomes protected in the manner previously described, and, likewise, may be restored to its original value before the tracked_reg_state may be restored to its original value. Likewise, restoring the tracked_reg_state permits a return to be completed. Thus, through this mechanism, control flow integrity on return may be maintained.

Note further that while this design effectively protects integer value or fixed point callee-save registers, it does not have sufficient space to protect floating point callee save registers, such as in RISCV64. While a malicious callee might perhaps alter the value of a floating-point callee-save register of a caller, this would not leak formal references. Floating point registers are not generally used to store pointers. Floating point registers are an optional feature of RISCV64 and computing systems that employ floating point software should be sufficiently protected by protecting fixed point registers. In addition, in most programs, floating point may not be used, making it potentially acceptable operation to treat RISCV64 callee-save floating point registers as caller save (using, for instance, GCC's-fcall-used-{regname}). If protection for callee-save floating point registers is a desire, it may be possible to extend the approach above by expanding the size of the tracked_reg_state or by chaining multiple tracked_reg_states in some fashion.

It may be tempting to suppose that the protection of callee-save registers may be appropriately handled with static analysis of the function operations involved, as had been previously discussed in connection with a verification that a stack location is not read before it is written. While this may be possible in some cases, static analysis for the present situation may be more challenging. In particular, it may be a challenge to check, using static analysis, that a stack location was not overwritten with another value without dynamic checks.

Likewise, for an embodiment, reducing risk of a leak from a caller-save register is desirable. While the above mechanism reduces risk of callee-save registers leaking references to their callees, references may still leak to callees through caller-save registers. At the same time, a function operation may intentionally share the contents of certain registers with a callee as function operation arguments. It may, therefore, be desirable to quickly clear reference flags on caller-save registers except those used as arguments before a call. One embodiment, for example, may “re-purpose,” so to speak, the previously-introduced ok_to_return flag as an ok_to_pass flag, allowing a check for registers individually regarding whether to pass them to a callee or to return. Likewise, for an embodiment, a clearing action on a call may be performed as may be done on a return. Such an embodiment involves a call check_ok_to_pass (renamed from check_ok_to_return) register by register. However, passing a stack_object_pointer reference to a callee does not have a risk of a passed reference persisting after a particular function operation returns.

In addition, in many architectures, the registers to pass arguments are well-known. For example, in RISCV64, a function operation that uses 4 registers to pass arguments will use registers a0, a1, a2, and a3 in accordance with standard calling convention. Thus, the number of registers used to pass arguments identifies which arguments should have their reference flags preserved and which ones should not.

For example, an embodiment may employ an operation, set_num_argument_registers, that takes as a value a number of argument registers to preserve. After setting this value, a computing system may clear reference flags on caller save registers not corresponding to the argument registers used to pass that number of arguments before the next call. This operation may occur during a call instruction, or may be performed immediately. In a situation in which reference flags are stored in a special bitfield register (such as described previously with respect to an embodiment of an check_ok_to_return mechanism), then the provided number of arguments may be employed by creating a mask for a bitwise AND operation with the value of the reference register to clear caller-save registers not intended to be used as arguments, storing the result back into the reference register.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, which generally refers to the ability for the client and server to transmit, receive, and/or exchange communications, as discussed in more detail later.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Additionally, in the present patent application, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, to be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modelled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

An example of a distributed computing system comprises the so-called Hadoop distributed computing system, which employs a map-reduce type of architecture. In the context of the present patent application, the terms map-reduce architecture and/or similar terms are intended to refer to a distributed computing system implementation and/or embodiment for processing and/or for generating larger sets of signal samples employing map and/or reduce operations for a parallel, distributed process performed over a network of devices. A map operation and/or similar terms refer to processing of signals (e.g., signal samples) to generate one or more key-value pairs and to distribute the one or more pairs to one or more devices of the system (e.g., network). A reduce operation and/or similar terms refer to processing of signals (e.g., signal samples) via a summary operation (e.g., such as counting the number of students in a queue, yielding name frequencies, etc.). A system may employ such an architecture, such as by marshaling distributed server devices, executing various tasks in parallel, and/or managing communications, such as signal transfers, between various parts of the system (e.g., network), in an embodiment. As mentioned, one non-limiting, but well-known, example comprises the Hadoop distributed computing system. It refers to an open source implementation and/or embodiment of a map-reduce type architecture (available from the Apache Software Foundation, 1901 Munsey Drive, Forrest Hill, Md., 21050-2747), but may include other aspects, such as the Hadoop distributed file system (HDFS) (available from the Apache Software Foundation, 1901 Munsey Drive, Forrest Hill, Md., 21050-2747). In general, therefore, “Hadoop” and/or similar terms (e.g., “Hadoop-type,” etc.) refer to an implementation and/or embodiment of a scheduler for executing larger processing jobs using a map-reduce architecture over a distributed system. Furthermore, in the context of the present patent application, use of the term “Hadoop” is intended to include versions, presently known and/or to be later developed.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communicating via the network in which the devices are able to communicate via one or more intermediate devices, such as of one or more intermediate nodes, but without the communicating devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

In the context of the present patent application, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g. signal communications) may employ intermediate devices of intermediate nodes to exchange signal packets and/or signal frames, those intermediate devices may not necessarily be included in the private network by not being a source or designated destination for one or more signal packets and/or signal frames, for example. It is understood in the context of the present patent application that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a public, self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present patent application, may comprise a service that organizes stored digital content, such as, for example, text, images, video, etc., through the use of hypermedia, for example. It is noted that a network, such as the Internet and/or Web, may be employed to store electronic files and/or electronic documents.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the term “Web site” and/or similar terms refer to Web pages that are associated electronically to form a particular collection thereof. Also, in the context of the present patent application, “Web page” and/or similar terms refer to an electronic file and/or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations.

In the context of the present patent application, the terms “entry,” “electronic entry,” “document,” “electronic document,” “content”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular patent application, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such via participating digital devices and may be substantially compliant and/or substantially compatible with, but is not limited to, now known and/or to be developed, versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, AppleTalk and/or the like. Versions of the Internet Protocol (IP) may include IPv4, IPv6, and/or other later to be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, or 4th generation (2G, 3G, or 4G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), 802.11b/g/n, and/or the like. A wireless network may include virtually any type of now known and/or to be developed wireless communication mechanism and/or wireless communications protocol by which signals may be communicated between devices, between networks, within a network, and/or the like, including the foregoing, of course.

In one example embodiment, as shown in FIG. 15, a system embodiment may comprise a local network (e.g., device 204 and medium 240) and/or another type of network, such as a computing and/or communications network. For purposes of illustration, therefore, FIG. 15 shows an embodiment 200 of a system that may be employed to implement either type or both types of networks. Network 208 may comprise one or more network connections, links, processes, services, applications, and/or resources to facilitate and/or support communications, such as an exchange of communication signals, for example, between a computing device, such as 202, and another computing device, such as 206, which may, for example, comprise one or more client computing devices and/or one or more server computing device. By way of example, but not limitation, network 208 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 15 may comprise features, for example, of a client computing device and/or a server computing device, in an embodiment. It is further noted that the term computing device, in general, whether employed as a client and/or as a server, or otherwise, refers at least to a processor and a memory connected by a communication bus. Likewise, in the context of the present patent application at least, this is understood to refer to sufficient structure within the meaning of 35 USC § 112 (f) so that it is specifically intended that 35 USC § 112 (f) not be implicated by use of the term “computing device” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIGS. 1-14 and in the text associated with the foregoing figure(s) of the present patent application.

Referring now to FIG. 15, in an embodiment, first and third devices 202 and 206 may be capable of rendering a graphical user interface (GUI) for a network device and/or a computing device, for example, so that a user-operator may engage in system use. Device 204 may potentially serve a similar function in this illustration. Likewise, in FIG. 15, computing device 202 (“first device” in figure) may interface with computing device 204 (“second device” in figure), which may, for example, also comprise features of a client computing device and/or a server computing device, in an embodiment. Processor (e.g., processing device) 220 and memory 222, which may comprise primary memory 224 and secondary memory 226, may communicate by way of a communication bus 215, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 204, as depicted in FIG. 15, is merely one example, and claimed subject matter is not limited in scope to this particular example.

For one or more embodiments, a computing device may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network, including, but not limited to, Facebook, LinkedIn, Twitter, Flickr, and/or Google+, to provide only a few examples. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 15, computing device 202 may provide one or more sources of executable computer instructions in the form physical states and/or signals (e.g., stored in memory states), for example. Computing device 202 may communicate with computing device 204 by way of a network connection, such as via network 208, for example. As previously mentioned, a connection, while physical, may not necessarily be tangible. Although computing device 204 of FIG. 15 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 222 may comprise any non-transitory storage mechanism. Memory 222 may comprise, for example, primary memory 224 and secondary memory 226, additional memory circuits, mechanisms, or combinations thereof may be used. Memory 222 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 222 may be utilized to store a program of executable computer instructions. For example, processor 220 may fetch executable instructions from memory and proceed to execute the fetched instructions. Memory 222 may also comprise a memory controller for accessing device readable-medium 240 that may carry and/or make accessible digital content, which may include code, and/or instructions, for example, executable by processor 220 and/or some other device, such as a controller, as one example, capable of executing computer instructions, for example. Under direction of processor 220, a non-transitory memory, such as memory cells storing physical states (e.g., memory states), comprising, for example, a program of executable computer instructions, may be executed by processor 220 and able to generate signals to be communicated via a network, for example, as previously described. Generated signals may also be stored in memory, also previously suggested.

Memory 222 may store electronic files and/or electronic documents, such as relating to one or more users, and may also comprise a computer-readable medium that may carry and/or make accessible content, including code and/or instructions, for example, executable by processor 220 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 15, processor 220 may comprise one or more circuits, such as digital circuits, to perform at least a portion of a computing procedure and/or process. By way of example, but not limitation, processor 220 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 220 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 15 also illustrates device 204 as including a component 232 operable with input/output devices, for example, so that signals and/or states may be appropriately communicated between devices, such as device 204 and an input device and/or device 204 and an output device. A user may make use of an input device, such as a computer mouse, stylus, track ball, keyboard, and/or any other similar device capable of receiving user actions and/or motions as input signals. Likewise, a user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

1. An apparatus comprising: an integrated circuit; wherein the integrated circuit comprises a processor;
wherein the processor comprises memory management capability for memory to be connected to the processor and to be accessed during execution of one or more programs, wherein the execution of the one or more programs comprises execution of processor instructions by the processor;
wherein the memory management capability includes the capability to maintain flow control between the execution of function operations implemented via the processor instructions;
wherein the capability to maintain flow control between the execution of function operations implemented via the processor instructions comprises the processor limiting, during execution of the processor instructions, access of another function operation to read from or write to stack memory address locations reserved for a particular function operation unless the another function operation has had a pointer granting access passed to it by the particular function operation during the execution of the processor instructions.

2. The apparatus of claim 1, wherein the capability to maintain flow control between the execution of function operations implemented via the processor instructions further comprises limiting access of the another function operation to read from or write to any stack memory address locations reserved for the particular function operation during execution of the processor instructions in which, after the particular function operation has relinquished flow control to other processor instructions being executed other than the processor instructions for the particular function operation.

3. An apparatus comprising: an integrated circuit; wherein the integrated circuit comprises a processor;
wherein the processor comprises memory management capability for memory to be connected to the processor and to be accessed during execution of one or more programs, wherein the execution of the one or more programs comprises execution of processor instructions by the processor;
wherein the memory management capability includes the capability to maintain flow control between the execution of function operations implemented via the processor instructions; wherein the capability to maintain flow control between the execution of function operations implemented via the processor instructions comprises, during the execution of function operations implemented via processor instructions, permitting a particular function operation access to the stack frame for the particular function operation but not permitting access to the stack frame for other function operations unless, during the execution of function operations implemented via processor instructions, the particular function operation calls another function operation and expressly grants to the another function operation access to its stack frame.

4. The apparatus of claim 3, wherein, during the execution of function operations implemented via processor instructions, to expressly grant access to the stack frame of the particular function operation comprises to expressly grant access to a limited portion of the stack frame of the particular function operation.

5. The apparatus of claim 3, wherein the capability to maintain flow control between the execution of function operations implemented via the processor instructions further comprises, during the execution of function operations implemented via processor instructions, tracking the status of registers used during execution of the particular function operation in a manner so that the registers contents are initially saved and so that the register contents are restored before completion of the execution of the particular function operation.

6. The apparatus of claim 5, wherein the registers used during execution of the particular function operation include: registers used by the particular function operation, registers used by the another function operation, and the return address register to return flow control to the processor instructions being executed after completion of the particular function operation.

7. A method comprising: implementing memory management for a memory connected to a processor; wherein the implementing memory management comprises maintaining flow control during execution of one or more programs;
wherein the maintaining flow control comprises:
limiting, during execution of processor instructions, access of another function operation to read from or write to stack memory address locations reserved for a particular function operation; and
granting access of another function operation to read or write to stack memory address locations reserved for the particular function operation comprising passing a pointer to the another function operation granting the access.

8. The method of claim 7, and further comprising: limiting access of the another function operation to read from or write to any stack memory address locations reserved for the particular function operation after the particular function operation has relinquished flow control to other processor instructions being executed other than the processor instructions for the particular function operation.

9. A method comprising: implementing memory management for a memory connected to a processor; wherein the implementing memory management comprises maintaining flow control during execution of one or more programs; wherein the maintaining flow control comprises:
permitting a particular function operation access to the stack frame for the particular function operation; and
permitting another function operation access to the stack frame for the particular function operation as a result of the particular function operation calling the another function operation and expressly granting access to its stack frame for the another function operation.

10. The method of claim 9, wherein, the expressly granting access to the stack frame of the particular function operation comprises expressly granting access to a limited portion of the stack frame of the particular function operation.

11. The method of claim 9, wherein the maintaining flow control further comprises:
tracking the status of registers used during execution of the particular function operation in a manner so that the registers contents are initially saved; and
restoring the registers contents before completing execution of the particular function operation.

12. The method of claim 11, wherein the registers used during execution of the particular function operation include: registers used by the particular function operation, registers used by the another function operation, and the return address register to return flow control to the processor instructions being executed after completion of the particular function operation.

13. An article comprising: a non-transitory storage medium; the storage medium having stored thereon instructions; the stored instructions being executable to implement memory management for a memory to be connected to a processor and to be accessed during execution of one or more programs, wherein the execution of the one or more programs comprises execution of processor instructions by the processor;
wherein the execution of the processor instructions by the processor to maintain flow control between the execution of function operations implemented via the processor instructions;
wherein the capability to maintain flow control between the execution of function operations implemented via the processor instructions comprises the processor limiting, during execution of the processor instructions, access of another function operation to read from or write to stack memory address locations reserved for a particular function operation unless the another function operation has had a pointer granting access passed to it by the particular function operation during the execution of the processor instructions.

14. The article of claim 13, wherein the capability to maintain flow control between the execution of function operations implemented via the processor instructions further comprises limiting access of the another function operation to read from or write to any stack memory address locations reserved for the particular function operation during execution of the processor instructions in which, after the particular function operation has relinquished flow control to other processor instructions being executed other than the processor instructions for the particular function operation.

15. An article comprising: a non-transitory storage medium; the storage medium having stored thereon instructions; the stored instructions being executable to implement memory management for a memory to be connected to a processor and to be accessed during execution of one or more programs, wherein the execution of the one or more programs comprises execution of processor instructions by the processor;
wherein the execution of the processor instructions by the processor to maintain flow control between the execution of function operations implemented via the processor instructions;
wherein the capability to maintain flow control between the execution of function operations implemented via the processor instructions comprises, during the execution of function operations implemented via processor instructions, permitting a particular function operation access to the stack frame for the particular function operation but not permitting access to the stack frame for other function operations unless, during the execution of function operations implemented via processor instructions, the particular function operation calls another function operation and expressly grants to the another function operation access to its stack frame.

16. The article of claim 15, wherein, during the execution of function operations implemented via processor instructions, to expressly grant access to the stack frame of the particular function operation comprises to expressly grant access to a limited portion of the stack frame of the particular function operation.

17. The article of claim 15, wherein the capability to maintain flow control between the execution of function operations implemented via the processor instructions further comprises, during the execution of function operations implemented via processor instructions, tracking the status of registers used during execution of the particular function operation in a manner so that the registers contents are initially saved and so that the register contents are restored before completion of the execution of the particular function operation.

18. The article of claim 17, wherein the registers used during execution of the particular function operation include registers: used by the particular function operation, registers used by the another function operation, and the return address register to return flow control to the processor instructions being executed after completion of the particular function operation
